(19) United States
(12) Patent Application Publication
(10) Pub. No.: US 2026/0032450 A1
(43) Pub. Date: Jan. 29, 2026

(54) METHODS FOR USER-AWARE TRUSTWORTHY INDIRECT SERVICE INTERACTION IN WIRELESS NETWORKS

(71) Applicant: InterDigital Patent Holdings, Inc., Wilmington, DE (US)

(72) Inventors: Chonggang Wang, Princeton, NJ (US); Xu Li, Plainsboro, NJ (US); Robert Gazda, Spring City, PA (US); Michael Starsinic, Newtown, PA (US); Samir Ferdi, Kirkland (CA); Ulises Olvera-Hernandez, Saint-Lazare (CA)

(73) Assignee: InterDigital Patent Holdings, Inc., Wilmington, DE (US)

(21) Appl. No.: 18/781,510

(22) Filed: Jul. 23, 2024

(51) Int. Cl. H04W 12/60; H04W 12/06

(52) U.S. Cl. CPC H04W 12/66; H04W 12/06

(57) ABSTRACT

A trust-index-aware service communication proxy (TIASCP) may be configured to receive, from a function entity service consumer (FESC), a first service operation request message that comprises a service operation request, send, to a trust management function (TMF), a FESC trust index retrieval request message, and receive, from the TMF, a FESC trust index retrieval response message that comprises a trust index of the FESC. The TIASCP may be configured to select a function entity service provider (FESP) based on the trust index of the FESC and to authenticate the service operation request based on the trust index of the FESC. The TIASCP may be configured to send, to the TMF, a FESP trust index retrieval request message and receive, from the TMF, a FESP trust index retrieval response message that includes a trust index of the FESP and authenticate the FESP based on the trust index of the FESP.

### BACKGROUND

A 5G system architecture comprises User Equipment (UE) or wireless transmit/receive units (WTRUs), a Radio Access Network (RAN), and a Core Network. A design principle for the 5G System (5GS) is service-centric or service-based. A 5G Core Network (5GC) follows Service-Based Architecture (SBA) and comprises a variety of Network Functions (NFs), which work together to fulfill and provide needed services to the RAN, WTRUs, and Application Servers/Service Providers. A WTRU interacts with the RAN/5GC via Non-Access Stratum (NAS) and Access Stratum (AS) signaling.

### SUMMARY

A trust-index-aware service communication proxy (TIASCP) may be configured to receive, from a function entity service consumer (FESC), a first service operation request message that comprises a service operation request. The TIASCP may be configured to send, to a trust management function (TMF), a FESC trust index retrieval request message. The TIASCP may be configured to receive, from the TMF, a FESC trust index retrieval response message that comprises a trust index of the FESC. The trust index of the FESC may comprise a user trust index (UTI) and/or a device trust index (DTI). The TIASCP may be configured to select a function entity service provider (FESP) based on the trust index of the FESC. The TIASCP may be configured to authenticate the service operation request based on the trust index of the FESC. The TIASCP may be configured to send, to the TMF, a FESP trust index retrieval request message. The TIASCP may be configured to receive, from the TMF, a FESP trust index retrieval response message that includes a trust index of the FESP. The TIASCP may be configured to authenticate the FESP based on the trust index of the FESP. The TIASCP may be configured to forward, to the FESP, a modified service operation request in a second service operation request message. The modified service operation request may comprise an identifier of the TIASCP. The TIASCP may be configured to receive, from the FESP, a service operation response message that comprises service operation results. The TIASCP may be configured to forward, to the FESC, the service operation results. A trust index may be a metric that indicates a level of trustworthiness and may be based on a trust evaluation of one or more trust indicators. The trust indicators may comprise factors related to at least one of: security, privacy, resilience, performance, robustness, scalability, reputation, availability, accuracy, reliability, or consistency. The TIASCP may be configured to receive, from the FESC, an authentication request message. The TIASCP may be configured to send, to the FESC, an authentication response message. The authentication request message may be a request for a trust index of the TIASCP. The authentication request message may comprise at least one of: an identifier of the FESP, an indication that indicates that the TIASCP should send its trust index back to the FESP; a user trust index (UTI), a device trust index (DTI), or a credential of the FESC. The first service operation request message may comprise at least one of: an identifier of a User of the FESC, an identifier of a device of the FESC, an identifier of the FESC, a credential of the FESC, a trust index of the user (UTI), a trust index of the device (DTI), an identifier of a trust management function (TMF) from which the UTI and DTI may be retrieved, an identifier of target services the FESC wants to access from a FESP, a type of requested service operation of the target services, an identifier of the FESP, a type of FESP, an indication that the TIASCP should send an immediate response to the FESP; or a timer value indicating that the TIASCP should send an immediate response to the FESC before the timer value expires. The FESC trust index retrieval request message to the TMF may comprise at least one of: an identifier of a user of the FESC, an identifier of a device of the FESC, an identifier of the TIASCP, or a credential of the TIASCP. Authenticating the FESP based on the trust index of the FESP may comprise: authorizing the FESP on a condition that the trust index of the FESP is greater than a trust index threshold value. The TIASCP may be configured to send a service operation request authentication notification message to the FESC, that indicates whether the service operation request is accepted, rejected, or buffered.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of 5G Security;

FIG. 3 shows an example of dynamical service access from a user;

FIG. 4 shows an example Dynamic Trust-based Authentication (DTA) architecture for a Request/Response-based indirect service interaction via a Trust-Index-Aware Service Communication Proxy (TIASCP);

FIG. 5 shows an example procedure for Dynamic Trust-based Authentication (DTA) for a Request/Response-based Indirect Service Interaction with a TIASCP, where the TIASCP does not authenticate a service operation request;

FIG. 6 shows an example procedure for Dynamic Trust-based Authentication (DTA) for a Request/Response-based Indirect Service Interaction with a TIASCP, where the TIASCP authenticates a service operation request;

FIG. 7 shows an example procedure for Dynamic Trust-based Authentication (DTA) for a Request/Response-based Indirect Service Interaction with a TIASCP, where the TIASCP dynamically authenticates buffered service operation requests;

FIG. 8 shows an example procedure for ETSI Permissioned Distributed Ledger (PDL) for TIASCP-based Indirect Service Interaction;

FIG. 9 shows an example procedure for PDL Service Interactions based on a TIASCP;

FIG. 10 shows a method for Dynamic Trust-based Authentication (DTA) for a Request/Response-based Indirect Service Interaction;

FIG. 11 shows a method for Dynamic Trust-based Authentication (DTA) for a Request/Response-based Indirect Service Interaction;

FIG. 12 shows a method for Dynamic Trust-based Authentication (DTA) for a Request/Response-based Indirect Service Interaction; and

FIG. 13 shows a method for Dynamic Trust-based Authentication (DTA) for a Request/Response-based Indirect Service Interaction.

### DETAILED DESCRIPTION

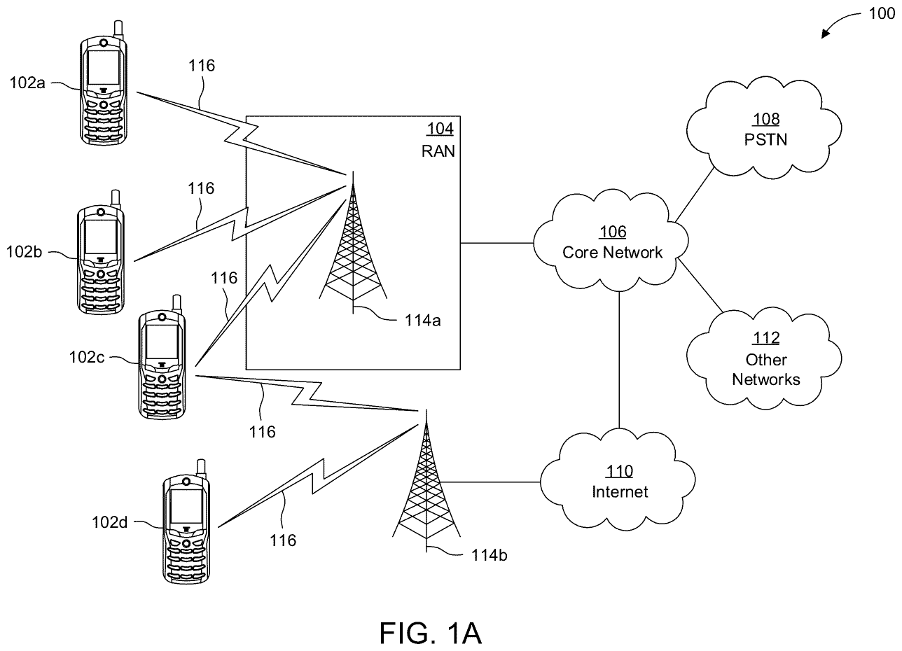

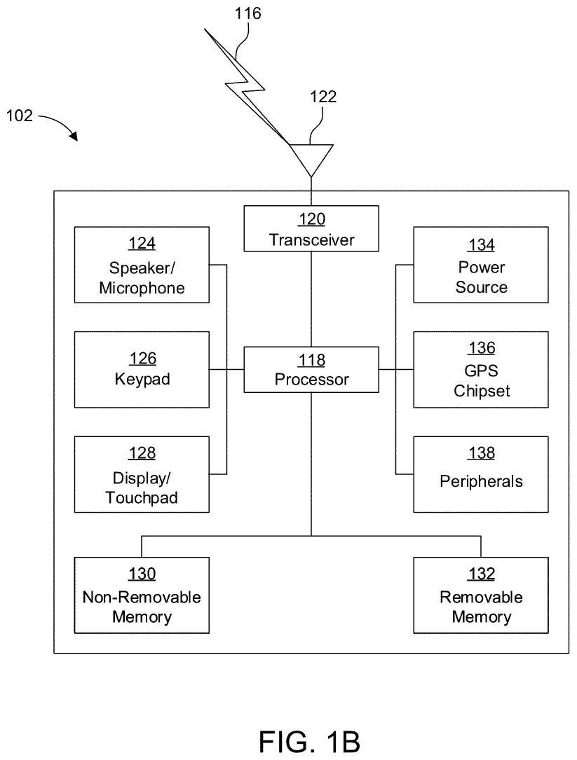

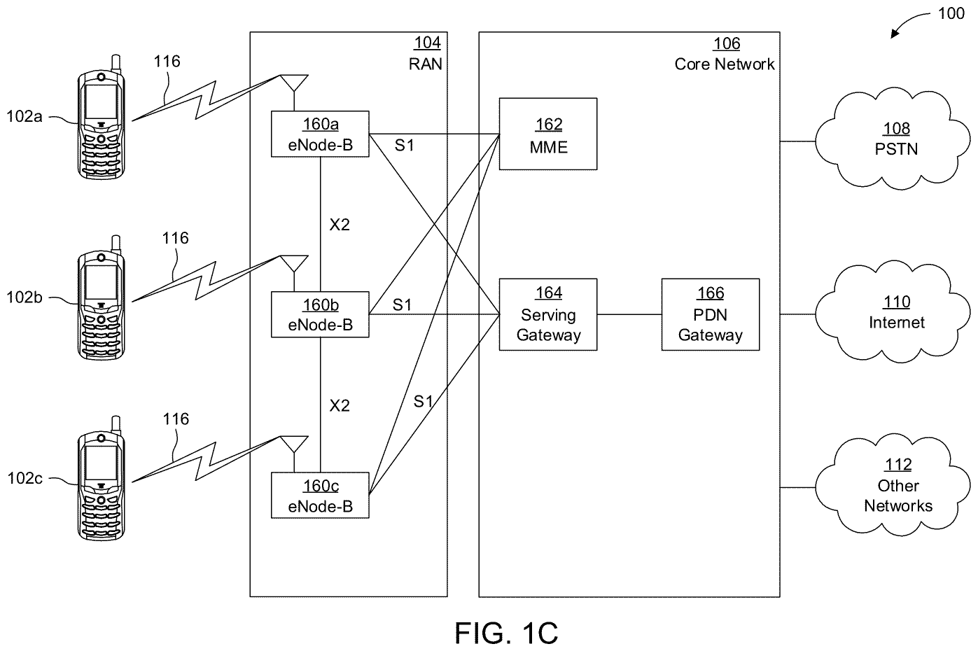

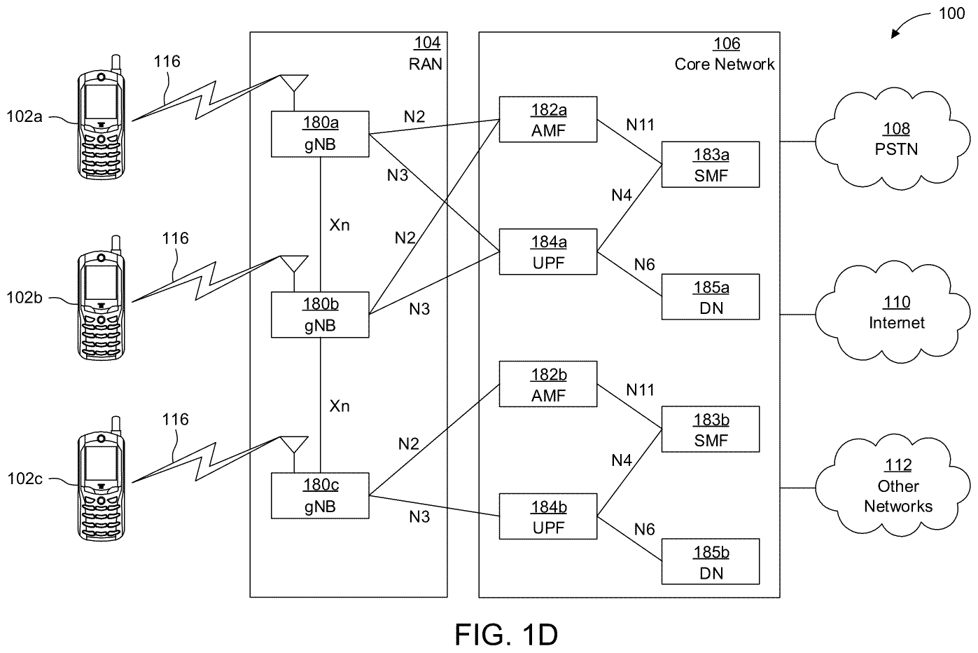

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A network function (NF) may access other network functions in a request/response mode or a subscription/notification mode. Before two NFs interact with each other, they first need to register with a Network Repository Function (NRF) so that they can discover each other via the NRF. Among these network functions, an Access and Mobility Management Function (AMF) is dedicated to managing WTRU's access to 5GS and its mobility. A Session Management Function (SMF) is responsible for establishing sessions between a WTRU and 5GC. An Authentication Server Function (AUSF) takes charge of WTRU authentication. A Policy Control Function (PCF) provides policy rules for other control plane network functions and WTRUs. A PCF assigns an identifier for each created policy rule, which other control plane network functions and WTRUs use to refer to the corresponding policy rule. A User Plane Function (UPF) is the only core network function in the data plane that facilitates monitoring, managing, controlling, and redirecting user plane traffic flows such as between a WTRU and an Application Function (AF). A Network Exposure Function (NEF) enables access to 5G control plane functions to entities such as network applications and AFs which are outside of 5GS and not in the same trusted domain.

Two NFs, one as a service consumer and the other as a service producer, may communicate with each other directly without any entity in the middle or indirectly via a Service Communication Proxy (SCP). A SCP is responsible for forwarding and routing messages between a NF service consumer and a NF service producer. In addition, two NFs may interact with each other using a Request/Response mode or a Subscribe/Notify model. In a Request/Response model, a NF service consumer may send a request to a NF service producer. The NF service producer may process the request and send a response to the NF service consumer. In a Subscribe/Notify model, a NF service consumer may send a subscription request to a NF service producer. The NF service producer may then process the subscription request and store the subscription information. Whenever any subscribed event occurs, the NF service producer may send a notification to the NF service consumer.

5GC provides data storage and analytics services through functions such as a Unified Data Management (UDM), a Unified Data Repository (UDR), an Unstructured Data Storage Function (UDSF), and a Network Data Analytics Function (NWDAF). A critical feature of 5GS is network slicing, which is facilitated by a Network Slice Selection Function (NSSF).

5GS introduces a few network functions such as a Location Management Function (LMF) to support location services. A LMF is responsible for calculating, determining, or verifying a final location and any velocity estimation and may estimate the achieved accuracy, based on location information from the target WTRU and/or a RAN node. After the LMF calculates the location of a target WTRU, other entities may access or query its location from the LMF but need to go through a serving AMF.

Although these network functions are defined as separate logical entities, a particular service scenario may require multiple network functions. For instance, WTRU mobility may need not only an AMF, but also an AUSF and an SMF. For a type of network function, multiple instances could be instantiated and a NRF may maintain the information of each instantiated network function instance. With the emergence of edge computing, some network functions in 5GC such as a UPF and an NEF may be deployed and resided in an edge network that is much nearer to and potentially co-located with the RAN.

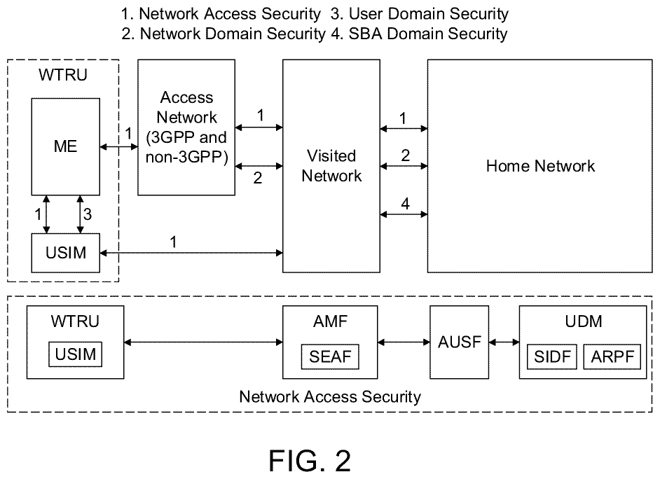

As shown FIG. 2, 5G security functions may cover different security domains within the 5G system such as: (1) Network Access Security which comprises security for network access between a WTRU and RAN/5GC, (2) Network domain security between RAN and 5GC, (3) User domain security between Mobile Equipment (ME) and Universal Subscriber Identity Module (USIM), and (4) SBA domain security in 5GC.

5G network access security is realized mainly through network access authentication, message encryption, and message integrity protection. Network access authentication includes primary authentication and key agreement, and secondary authentication.

The primary authentication and key agreement are designed to enable: 1) mutual authentication between a WTRU and a network; and 2) agreed keying material (e.g., an anchor key K_{SEAF}) at both the network side and the WTRU side. The basis behind 5G primary authentication and key agreement is that the same long-term key K unique to a WTRU is securely maintained at USIM and the network, based on which the anchor key K_{SEAF} and other key materials (e.g., keys for encryption and integrity protection for NAS and AS signaling) can independently and identically be derived at the WTRU and at the network, without exchanging them over the air. Mutual authentication is established when the WTRU and the network prove to each other they know the same long-term key K. Since the primary authentication is solely based on the long-term key K, it does not consider user-centric aspects (e.g., user behaviors) and cannot authenticate/differentiate users from the same or different WTRUs.

The secondary authentication is designed as an option to provide security between the WTRU and an external Data Network (DN) as a part of session management. The secondary authentication relies on the SMF to initiate and coordinate the authentication procedure between the WTRU and the DN (e.g., a DN-AAA Server).

A blockchain system may be: 1) a permissionless blockchain system (e.g., Bitcoin, Ethereum) where any party or user may use and participate in the blockchain system without pre-granted permissions; or 2) a permissioned blockchain system where access to the blockchain system needs to be permissioned, controlled and/or governed. Permissioned Distributed Ledgers (PDL) as defined by ETSI Industry Specification Group (ISG) on PDL is an example of permissioned blockchain systems.

ETSI ISG on PDL publishes Group Reports (GR) and Group Specifications (GS) on various topics such as PDL reference architecture, use cases, specific PDL functionalities, and vertical domains.

ETSI GR PDL-021 describes use cases where PDL may be leveraged and integrated with 3GPP system such as 5GS.

ETSI GS PDL-024 develops standards for provisioning PDL services within the 3GPP system. Three functions are being defined in ETSI GS PLD-024: Distributed Ledger Anchor Function (DLAF), Distributed Ledger Repository Function (DLRF), and Distributed Ledger Enabler (DLE). DLAF and DLRF are introduced as two new control plane functions for the 3GPP system, while DLE likely will be a data plane function.

ETSI GS PDL-027 aims to develop and specify the technical requirements and solutions based on PDL to build a native Self-Sovereign Identity (SSI) system under the constraints of telecom networks so that a user or a network node holding such an identity may access network services among different operators and service providers seamlessly.

Trust refers to a measurable belief that represents an accumulated value (e.g. about the quality/behavior/performance/characteristic of a network node, a WTRU, a service or any logical/physical entity) from history and the expected value for the future. Trust may be an objective trust or a subjective trust. The objective trust leverages the security mechanism, such as authentication, to validate an entity's identity. However, trust covers and is beyond security. For example, an entity passing the authentication only means the entity has successfully proved its identity, and it still may not be fully trusted since the trust about the entity's behavior/characteristics may still be dynamically changing and the criteria for evaluating trust may also be subjective (e.g. based on user/personal experience/preference). Trust is an essential input for decision making and it is usually measured or calculated based on the history experience/records in the past, and it represents the expected value of quality, behavior, characteristics, and/or performance in the future.

A Trust Index may be obtained via a Trust Evaluation process. A trust index may be used to describe the trust of an entity. The trust index is an overall metric, which is often calculated based on the aggregation of one or more Trust Indicators, depending on the user's subjective trust evaluation criteria, using certain trust evaluation algorithms. The trust indicators may cover various aspects, such as security, privacy, resilience, performance, robustness, scalability, availability, accuracy, reliability, and consistency. During a trust evaluation process, various data about an entity may be collected and those data could be used as inputs to calculate various trust indicators, which in turn may be aggregated into an overall metric (i.e. the current trust index of the entity). Trust has various characteristics. For example, trust is dynamic, meaning that a given trust index may be applicable for a limited time period and may change as time goes on. Trust is also context-dependent, which means that the trust may have a significant change if the context changes. Trust is not transitive in nature, but trust may be transitive in some particular contexts. Similarly, trust is an asymmetric relationship, meaning that a fact of entity A trusting entity B cannot deduce that entity B also trusts entity A. In addition, trust may also be subjective, which means for the same entity, different users may have different criteria/opinions/preferences regarding how to evaluate the trust of this entity and what kinds of trust-related aspects/indicators shall be considered.

Existing cellular wireless systems (e.g., 5GS) provide various security functions such as primary authentication during registration, secondary authentication during Protocol Data Unit (PDU) session establishment, NF service authorization, network slicing-specific authentication and authorization, network slicing admission control, and data plane encryption and integrity protection.

NF service authorization in 5GS may be static authorization or token-based authorization.

In static authorization, some local authorization policies are maintained at the NRF and the NF service producer. Those local authorization policies may be used to authorize a NF service consumer, when the NF service consumer discovers the NF service producers from the NRF or when it requests to access services from a discovered NF service producer.

In token-based authorization, the NRF may grant an access token to a NF service consumer. The NF service consumer may then present the access token to the NF service producer, which may authorize the NF service consumer based on the access token.

In future wireless systems, a user may access services provided by a network and/or a WTRU with highly dynamic behavior. Examples of services may be: NWDAF, AI as a Service (AIaaS), Computation as a Service (CaaS), and Sensing as a Service. Dynamic behaviors may be for the user to access services from a new location, to access services via different devices at different times, or to switch to access services provided by another device for a reduced latency or other improvement in performance or experience. Such dynamic behaviors may lead to changing trustworthiness among interacting and involved entities (e.g., users, devices, NFs, networks). For example, a previously established relationship between a user and a NF may become not trustable anymore. The user may be a human user, an application on a device, an application within a network, a device behind another device, or other logical entity as a service consumer.

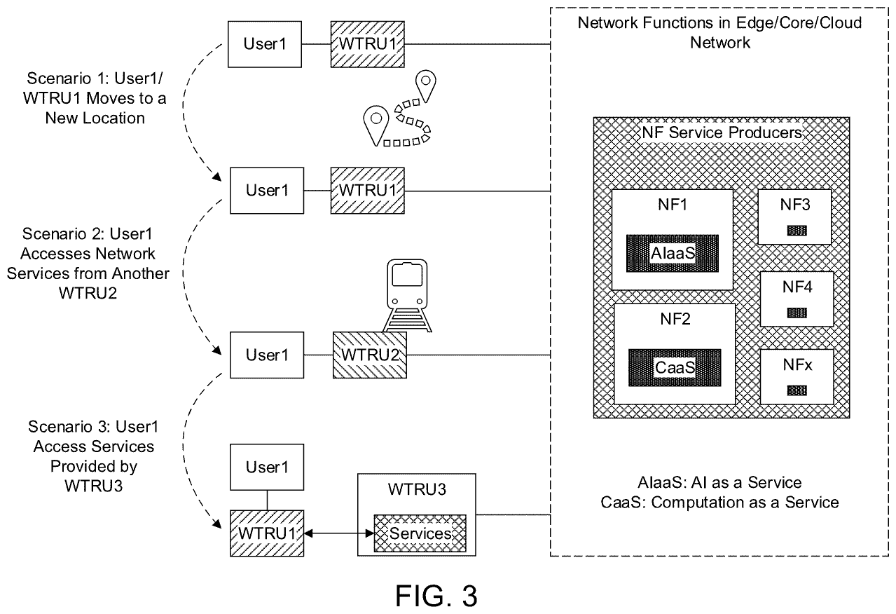

FIG. 3 shows three scenarios for dynamic service access from a user in future mobile networks.

In Scenario 1,User1 currently uses WTRU1. User1/WTRU1 moves to a new location (e.g., a train station) and continues to access services from a network (e.g., AI as a service (AIaaS) provided by NF1). Moving to a public area with more potential security attacks may lead to a change to the trust of User1/WTRU1.

In Scenario 2, the train has a mounted WTRU (i.e., WTRU2), which provides better wireless connectivity and overall performance to the user while the training is moving. User1 gets on the train and changes to associate with and use WTRU2 to access network services (e.g., computation as a service (CaaS) provided by NF2). For example, WTRU2 may provide a WiFi-based hotspot service within the train. Each seat may have a build-in WiFi terminal. As a result, User1 uses the built-in WiFi terminal to connect to WTRU2 and eventually get to access network services. Alternatively, User1 may still use WTRU1 to connect to WTRU2 (e.g., via WiFi or sidelink), and then get to access network services.

In Scenario 3, while using AIaaS from NF1, User1/WTRU1 arrives at a shopping mall and gets off the train. It turns out that WTRU3 (e.g., a WTRU at a store) in the proximity of WTRU1 also provides needed AIaaS. AIaaS on WTRU3 may provide a store-customized AI model for shopping suggestions for free. User1 changes to access AIaaS services from WTRU3 and stops using AIaaS from NF1.

In the dynamic service access scenarios of FIG. 3, User1's context (e.g., the location of User1, the WTRU that User1 is associated with, and the location of services being accessed) changes from time to time. As such, the trust index of User1 may change. Therefore, to authorize if User1 is allowed to access network services or services provided by a WTRU needs to be dynamically (re-)assessed.

Current 5GS has limitations in supporting the above scenarios.

5GS does not consider dynamic user context and does not well support dynamic user authentication. Primary authentication in 5GS is based on statically configured information (i.e., the root key in USIM), which cannot reflect or capture the dynamically changing user context and user trust index. Static authorization in 5GS is only based on local authorization policies, which cannot reflect or capture the dynamically changing user context and user trust index. In token-based authorization in 5GS, an access token cannot reflect or capture the dynamically changing user context and user trust index.

5GS does not support dynamic user authentication based on a user trust index. Although some existing solutions about user identifier and user authentication are proposed, they do not reflect or support a user trust index.

A technical issue that needs to be addressed include how to support dynamic user authentication leveraging trust so that service access in a future wireless system will be user-aware and trustworthy. Without solutions for this issue, the wireless system may just authenticate a user once and the user may access network services for a long time, even when the user context changes and results in a degraded user trust index or a service provider's trust changes. Thus, the wireless system may be less secure and more vulnerable from potential attacks.

Another issue is that existing request/response-based indirect service interaction via a SCP does not consider trustworthiness under dynamic service access scenarios. When an SCP is used as an intermediary proxy between a NF service consumer and a NF service producer, existing 5GS employs implicit authentication, which relies on authentication between the NF service consumer and the SCP, and between the SCP and the NF service producer. However, the existing SCP does not consider any dynamic trust index of the NF service consumer or the NF service producer. Furthermore, the trust index of the SCP also may dynamically change. As a result, existing SCP mechanisms or procedures may fail to establish trustworthy indirect service interactions between the NF service consumer and the NF service producer when their trust index dynamically changes.

An issue that needs to be addressed is how an SCP uses the trust index of a NF service consumer and NF service producer to (re-)select a pair of matching NF service consumer and NF service producer.

Another issue that needs to be addressed is how an SCP uses the trust index of a NF service consumer to authenticate if the message from the NF service consumer may be forwarded to the selected NF service provider.

Another issue that needs to be addressed is how an SCP may be authenticated with its trust index by both the NF service consumer and the NF service producer.

A device may be UE or WTRU. A device may also be a non-WTRU, which may connect to a WTRU via a non-cellular link to get to a cellular network. A device may have one or multiple on-device applications.

A user may be an entity, such as a human user, but not necessarily a human user, that uses a device. A user may be outside of a device or an entity within the device. A NF consumer may be a user. An FESC may be a user. An application running on a WTRU may be regarded as a user. A WTRU (especially a WTRU without a USIM) may also be regarded as a user. A device that uses a WTRU to get access to a network such as a 3GPP network may also be a user of this WTRU.

A Function Entity (FE) may be a processing function such as network functions. A FE may also be an AF, a function at an edge network, a function at a radio access network, a function at a core network, an edge application or service, a service provided by a device, an application provided at a device, or a server or service in a data network.

A FE Service Consumer (FESC) may be an FE that accesses services provided by FE service producers (e.g., NF service producer). A FE service consumer may be a NF service consumer. A device may be a FESC. A single device may have multiple FESCs.

A FE Service Producer (FESP) may be a FE that provides services to FE service consumers. A FE service producer may be a NF service producer, an AF, an edge application service, a service enabler, or a service on another device. A device may be a FESP. A single device may have multiple FESPs.

A Trust Index may be a metric to show/represent/reflect the trustworthiness of a logical or a physical entity (e.g., a device, a user, or a FE). A Trust index may be an absolute floating number or an integer. In this case, the higher the trust index of the entity is, the more trustworthy the entity is. A Trust index also may be categorical data to indicate multiple levels of trust (e.g., “very low trust”, “low trust”, “medium trust”, “high trust”, or “every high trust”, and so on). As a result, a trust index threshold may be a number or a trust level. A Trust index may be calculated during a long or a short period of time and thus it may be an instantaneous trust index or an average trust index. A Trust index of an entity may be a reputation value of this entity or based on a reputation value of this entity.

A Device Trust Index (DTI) may be a Trust index of a device.

A User Trust Index (UTI) may be a Trust index of a user.

A Trust Management Function (TMF) may be a FE that may assess and calculate a trust index of an entity (e.g., a device, a user, an AF, a NF, a service, or an application). A TMF may also expose the calculated trust index to other FEs. A TMF may assess and calculate the trust index of FESCs and FESPs.

An Identifier may be a name/identifier/address of an entity (e.g., a user, a device, a FE, or an entity using a device,). An identifier may be a 3GPP identifier, an IP address, a URL (Uniform Resource Locator), a FQDN (Fully Qualified Domain Name), a blockchain address, or a distributed user identifier. The identifier of an entity enables or provides access details based on which other entities may access and interact with this entity.

A Distributed User Identifier (DUID) may be a special type of unique identifier for a user that may be created and owned by the user without relying on a third party. A DUID may be independently formed or established by the user using a DUID generation algorithm or function, which may be based on some unique and private information of the user such as a private key, user attributes or properties, or user biometrics. An entity (e.g., a device, an application on the device, a service provided at a device, or a NF) may create and possess a DUID.

A Distributed Verifiable User Credential (DVUC) may be a credential being created or issued for a user. A DVUC may be verified and authenticated in a distributed way without contacting the party that creates the DVUC. A user may have one or multiple DVUCs. When an unauthorized user needs or wants to access services from an entity such as a NF, the user may present a DVUC to the entity to get the DVUC authenticated and eventually establish a trust relationship with the entity offering services. A new DVUC may deprecate an existing DVUC. A new DVUC may be dependent on one or multiple existing DVUC.

Multiple embodiments are proposed for trust-based authentication considering a user trust and/or a device trust for a service consumer and the trust index of a service producer, which may have the following design principles and benefits.

Design principles may include: 1) flexible and applicable for different use cases (e.g., scenarios in shown in FIG. 3); 2) avoid introducing high communication or computation overhead to devices; 3) compatible with 3GPP architecture; 4) integration with 3GPP SA procedures.

Benefits may include: 1) a more user-aware wireless system by incorporating user trust index, device trust index, and service producer trust into user authentication; 2) more secure service interaction via trust-based authentication considering dynamically changing user trust index.

To enable trustworthy indirect service interactions between a FESC (e.g., a user) and a FESP (e.g., a NF), a Trust-Index-Aware SCP (TIASCP) is proposed replacing or enhancing an existing SCP The TIASCP may consider the trust index of the FESC and the FESP as a part of its authentication and authorization with both the FESC and the FESP. In addition, the trust index of the TIASCP may also be considered.

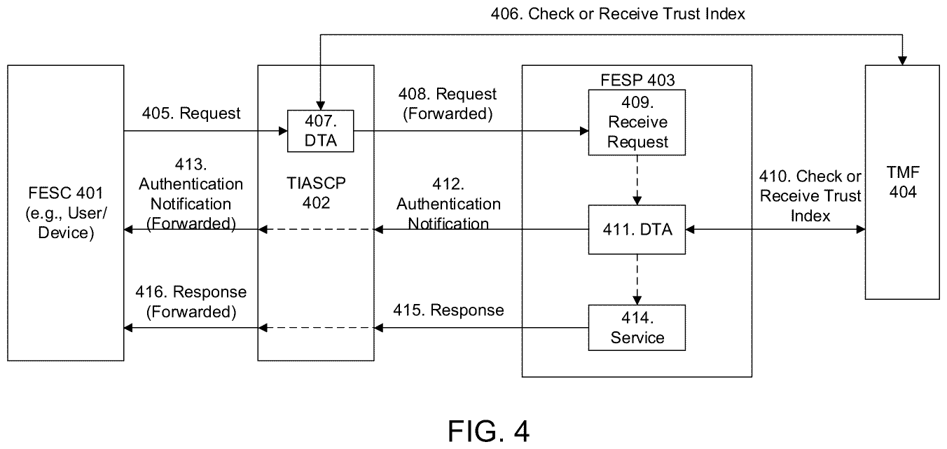

FIG. 4 shows a Dynamic Trust-based Authentication (DTA) architecture for a Request/Response-based indirect service interaction via a TIASCP. In this architecture, a Function Entity Service Consumer (FESC) may be a user or a device A Function Entity Service Producer (FESP) may be a NF, an AF, an edge application service, a service enabler, or a service on another device. The FESC may need to access a target service provided or hosted by the FESP. The FESC cannot or may choose not to interact with the FESP directly. Instead, a Trust-Index-Aware Service Communication Proxy (TIASCP), as an intermediary node between the FESC and FESP, is responsible for relaying/forwarding/routing/load balancing messages between the FESC and FESP.

As shown in FIG. 4, the FESC (e.g. User/Device) 401 may send a message (e.g. request message) 405 to the TIASCP 402 for accessing a target service from the FESP 403. The TIASCP 402 may retrieve or receive a trust index 406 of the FESC from a Trust Management Function (TMF) 404. For example the TIASCP 402 may send a message to the TMF 404 requesting the trust index of the FESC 401 and the TMF 404 may (re) calculate and send the trust index (e.g. information indicating the trust index) of the FESC 401 to the TIASCP 402. The TIASCP 402 may use the trust index of the FESC to perform a Dynamic Trust-based Authentication (DTA) 407 of the request for accessing a target service received from the FESC. Based on the DTA result, the TIASCP may select appropriate FESPs and determine whether and how to route/forward/relay the request for accessing a target service to a selected FESP. If the FESP offloads a DTA (see 411) here, the TIASCP may determine if the FESC is allowed to access the target service based on the trust index of the FESC. The TIASCP may forward/send the request received from the FESC to the selected FESP 408. The FESP may receive the request from the TIASCP and may perform processing (e.g., credential-based authentication) 409. The FESP may retrieve or receive the trust index of the FESC from the TMF 410. For example the FESP may send a message to the TMF requesting the trust index of the FESC and the TMF may (re)calculate and send the trust index (e.g. information indicating the trust index) of the FESC to the FESP. The FESP may use the trust index of the FESC to perform a DTA of the request for accessing a target service received from the TIASCP to determine if the FESC may access the target service 411. The FESP may offload this DTA to the TIASCP. Thus, as discussed above, if the FESP offloads the DTA, the TIASCP may determine if the FESC is allowed to access the target service based on the trust index of the FESC (see 407). The FESP may send an authentication message or notification 412 to the FESC, via the TIASCP, which may comprise a trust-based authentication result. For example, the FESP may send the authentication message 412 to the TIASCP and the TIASCP may forward/send the authentication message 413 to the FESC. If the FESC is allowed to request or access the target service according to the trust-based authentication, the FESP may execute the target service for the FESC 414. When the execution of the target service is completed, the FESP may collect service results, provide them in a response, and send the response to the TIASCP 415, which may forward the response to the FESC 416.

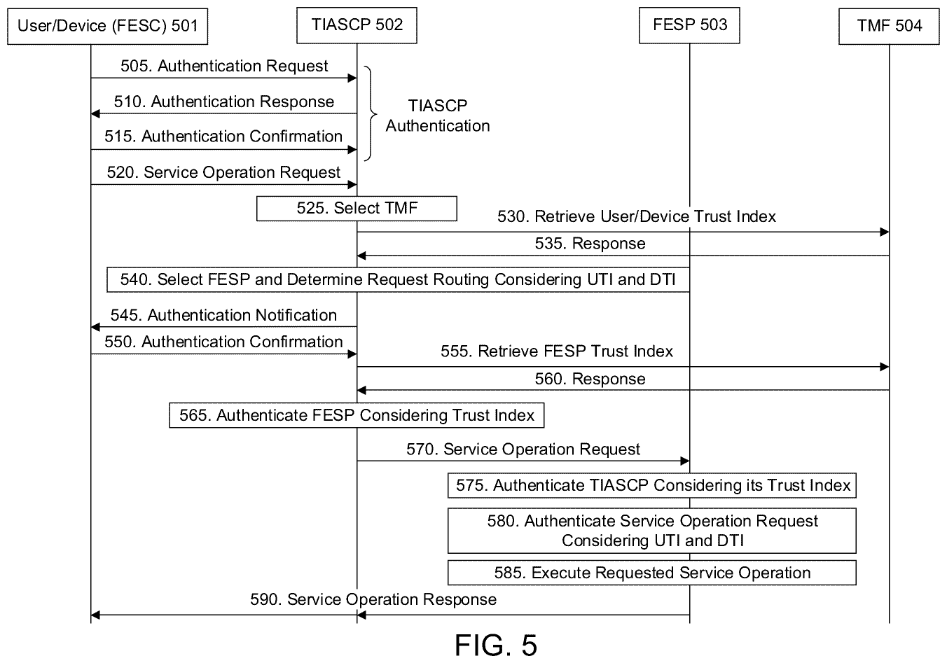

FIG. 5 shows an example procedure for Dynamic Trust-based Authentication (DTA) for a Request/Response-based Indirect Service Interaction with a TIASCP, where the TIASCP does not authenticate a service operation request.

FIG. 5 includes the following four logical entities. A User/Device 501 may be a User using a Device or behind the Device. The User/Device may be a service consumer which may request to access services provided by a FESP. The User/Device may be a Function Entity Service Consumer (FESC).

A Function Entity Service Producer (FESP) 503 may be within a network (e.g., 5G or 6G network) or on a device. The FESP may be a service producer that provides services to service consumers (e.g. User/Device, FESC).

A Trust Management Function (TMF) 504 may provide services for evaluating, calculating/determining, and exposing a User Trust Index (UTI), a Device Trust Index (DTI), a trust index of an FESP, a trust index of a TIASCP. The TMF may be within a network (e.g., 5G or 6G network) or a third-party entity.

A Trust-Index-Aware Service Communication Proxy (TIASCP) 502 may be with a network (e.g., 5G or 6G network) or on a device.

In the embodiment of FIG. 5, a User, via a Device, or a Device may request to access target services provided by a FESP. The User/Device may not directly interact with the FESP, but may interact indirectly via an intermediary TIASCP. The TIASCP may determine if the User/Device is allowed to use the TIASCP forwarding service based on, for example, a UTI and/or a DTI. For example, if the User/Device has a high UTI/DTI (e.g. greater than a threshold UTI/DTI) and is trustable enough, the TIASCP may forward the request of the User/Device to the FESP. Before providing the requested services to the User/Device, the FESP may perform a dynamic trust-based authentication (DTA) of the User/Device request received from the TIASCP, to determine if the User/Device is allowed to access the requested service(s). For trust-based authentication, the FESP may retrieve the UTI and/or DTI from the TMF, based on which FESP determines if the User/Device can be trusted. The FESP may send an authentication result message to the User/Device via the TIASCP and may start to execute the requested service(s). The FESP may send the service execution results to the TIASCP, which may forward/send the results to the User/Device.

A User/Device may discover or may be provisioned or preconfigured with a TIASCP. The User/Device may send a message (e.g. an authentication request message) to the TIASCP for the purpose of authenticating the TIASCP 505. The authentication request message may comprise one or more of the following parameters. The authentication request message may comprise an identifier of the User and/or the identifier of the Device. The authentication request message may comprise an indication or information that indicates that the TIASCP needs to or should send its trust index back to the User/Device (e.g. TIASCPAuthInfo=“TrustIndex”). The authentication request message may comprise the trust index of the User (UTI) and/or the trust index of the Device (DTI). The UTI and the DTI may be optional. If the UTI and the DTI are included in the authentication request message, the TIASCP may skip retrieving the UTI and DTI from the TMF (see 530 and 535). The authentication request message may comprise credentials of the User/Device such as a DVUC or an access token.

The TIASCP may receive the authentication request from the User/Device. The TIASCP may process the authentication request and send an authentication response message 510 to the User/Device. For example, the TIASCP may authenticate the authentication request based on the credentials of the User/Device. If the credentials are valid, the TIASCP may continue to process the authentication request. If the credentials are not valid, the TIASCP may stop processing the authentication request and send a rejection indication in the authentication response message to the User/Device. If TIASCPAuthInfo=“TrustIndex” was indicated in the authentication request message and if the TIASCP does not have its trust index, the TIASCP may send a request message to a TMF and receive its trust index from the TMF. If the UTI and/or the DTI were included in the authentication request message, the TIASCP may authenticate and authorize the User/Device considering the UTI and the DTI. For example, if the UTI is above a UTI threshold value and the DTI is above a DTI threshold value, the TIASCP may regard or consider the User/Device trustable and may permit the User/Device to use its communication proxy service (e.g., send a service operation request; see 520). The TIASCP may generate an authentication response, which may include, for example: 1) the trust index of the TIASCP; 2) the credential(s) of the TIASCP; 3) the identifier of the TIASCP; and/or 4) if the User/Device is permitted to use the TIASCP's services. The TIASCP may send the authentication response message to the User/Device.

The User/Device may receive the TIASCP authentication response. The User/Device may use the trust index of the TIASCP, and optionally together with its credential, to authenticate and authorize the TIASCP. For example, if the trust index of the TIASCP is above a threshold value and/or if its credential is valid, the User/Device may regard or consider the TIASCP is trustable and may continue to use its services (e.g., send a service operation request; see 520). The User/Device may send an authentication confirmation message to the TIASCP indicating if the TIASCP has been successfully authenticated and authorized 515. In the authentication confirmation message, the User/Device may indicate that the TIASCP later only needs to determine how to route/forward a service operation request to the FESP (see 535), and leave the authentication of service operation request to be done to the FESP (see 580). The actions performed in 505-515 may be considered TIASCP authentication. Once the actions in 505-515 have been performed and the TIASCP has been authenticated, the actions in 520-590 may be repeated multiple times without performing the actions in 505-515 again (i.e. TIASCP authentication).

The User/Device may send a service operation request message 520 to the TIASCP. The service operation request may comprise one or more of the following parameters. The service operation request may comprise the identifier of the User and/or the identifier of the Device. The service operation request may comprise the credentials of the User/Device. The service operation request may comprise the trust index of the User (UTI) and/or the trust index of the Device (DTI), signed by a TMF. This parameter may be optional. The service operation request may comprise an identifier of a TMF from which the UTI and DTI may be retrieved (e.g. TMFID). This parameter may be optional. The service operation request may comprise an identifier or a name of target services the User/Device wants or requests to access from the FESP (e.g. ServiceID). The service operation request may comprise a type of requested service operation on the target services as denoted by the ServiceID (e.g. ServiceOperationType). The service operation request may comprise an identifier of the FESP (e.g. FESPID). This parameter may be optional. If the FESPID is not included, a FESPType will be needed. The service operation request may comprise a type of FESP (e.g. FESPType). Using this parameter and/or ServiceID, the TIASCP may select a trustable FESP and forward the service operation request to the selected FESP (see 570). The service operation request may comprise an indication (e.g. ImmediateResponseFlag) that the TIASCP needs to or should send an immediate response to the User/Device (after sending the service operation request to the FESP) and before an ImmediateResponseTimer expires. The service operation request may comprise a timer (e.g. ImmediateResponseTimer) or a time period indicating that the TIASCP needs to or should send an immediate response to the User/Device after the action performed in 570 and before this timer or time period expires.

The TIASCP may select (or reselect) a TMF, from which the TIASCP may retrieve or verify the UTI/DTI 525. For example, the TIASCP may send a request message comprising the identifiers of the User/Device to a repository function (e.g., NRF). The repository function may search its local TMF repository against the identifiers of the User/Device to find an appropriate TMFs which may calculate/determine and expose a trust index of the User/Device. The repository function may send one or multiple founded TMFs to the TIASCP. In an example, the TIASCP may have been provisioned or preconfigured with a list of TMFs, from which the TIASCP may choose one that may calculate/determine and expose a trust index of the User/Device. If a TMFID is included in the service operation request from the User/Device to the TIASCP, the TIASCP may use the TMF as denoted by the TMFID.

The TIASCP may send a trust index retrieval request message 530 to the determined or identified TMF. The trust index retrieval request may comprise an identifier of the User (e.g. UserID), an identifier of the Device (e.g. DevID), an identifier of the TIASCP (e.g. TIASCPID), ServiceID, FESPType, and/or the credential of the TIASCP.

The TMF may recalculate UTI and/or DTI according to the parameters included in the trust index retrieval request and send a trust index retrieval response 535 to the TIASCP comprising the latest UTI and DTI. In an example, if the UTI and DTI were included in the service operation request from the User/Device to the TIASCP, the TIASCP may include the UTI/DTI in the trust index retrieval request and request the TMF to verify the UTI/DTI. The TMF may receive the UTI/DTI and verify both parameters. Then the TMF may not include the UTI/DTI in the trust index retrieval response to the TIASCP, but indicate if both parameters are valid or invalid. In another example, if the UTI and DTI and the TMF's signature on both were included in the service operation request from the User/Device to the TIASCP, the TIASCP may be able to directly verify the UTI and DTI by verifying the TMF's signature without contacting the TMF (e.g., using the TMF's public key).

The TIASCP may receive the trust index retrieval response. The TIASCP may continue to process the service operation request 540. If the FESPID was not included in the service operation request from the User/Device to the TIASCP, the TIASCP may select an appropriate FESP, for example, according to or based on the FESPType, ServiceID, UTI, and/or DTI. For example, the UTI and DTI should meet the selected FESP's requirement on user trust index and/or device trust index. Based on the received UTI and DTI, the TIASCP may determine how to forward or route the service operation request from the User/Device to the TIASCP to the selected FESP. As an example, if the UTI and/or DTI is below a threshold value, the TIASCP may reject the service operation request from the User/Device to the TIASCP. Then, it may send a rejection notification message to the User/Device and the procedure may stop. In another example, if the UTI and/or DTI is above a threshold value, the TIASCP may agree to forward the service operation request to the selected FESP. If the UTI and/or DTI is below a threshold value or within a trust index range or beyond a trust index range, the TIASCP may select a FESP with a capability of performing dynamic trust-based authentication (DTA). In another example, the TIASCP may forward the service operation request from the Users/Devices with close UTI/DTI to the same FESP. In another example, if the UTI/DTI is below a threshold value or within a trust index range or beyond a trust index range, the TIASCP may not reject the service operation request, but determine to buffer it for a period of time. The period of time may be adjusted when the UTI/DTI changes (e.g. increases or decreases). Then, the TIASCP may request the TMF to monitor the trust index of the User/Device and send any updated UTI/DTI to the TIASCP. For each permitted service operation request, the TIASCP may assign a unique identifier (e.g. ReqID), which may be generated based on the identifier of the User, the identifier of the Device, the identifier of the TIASCP, a sequence number, the time when the service operation request was received by the TIASCP, and/or a random number.

The TIASCP may send an authentication notification message 545 to the User/Device. The authentication notification may inform the User/Device what has been determined in 540 including the selected FESP (e.g. whether the service operation request is accepted, rejected, or buffered). The authentication notification may also include information regarding the trust index retrieval response. If a new TMF was selected, the TMFID of the new TMF may also be included in the authentication notification. A ReqID may be included in the authentication notification message 545. The trust index of the TIASCP may be included in the authentication notification message. The authentication notification message may include a buffering period that the TIASCP may have determined in 645 for buffering the service operation request for a time duration as denoted by the buffering period.

The User/Device may receive and store the authentication notification and send an authentication confirmation message 550 to the TIASCP. Using the authentication confirmation, the User/Device may indicate its agreement or disagreement with what is included in the authentication notification. For example, if the service operation request was determined to be buffered, the User/Device may indicate to cancel the service operation request (e.g., include ReqID in the authentication confirmation message and indicate “cancellation”), for example, if the trust index of the TIASCP is below a threshold value and/or the determined buffering period is higher than a threshold value. In this case, the procedure may be stopped and the TIASC may remove the service operation request from its local storage. Before forwarding the service operation request to the selected FESP, the TIASCP may need to perform dynamic trust-based authentication (DTA) over the selected FESP (see 555-565). For example, when it takes a longer time for the TIASCP to receive the last service operation response from the FESP, the TIASCP may perform such trust-based authentication for the FESP. In another example, when the FESP was selected for the first time, the TIASCP may also perform such trust-based authentication for the FESP.

The TIASCP may send a request message 555 (i.e. trust index retrieval request) to the TMF to retrieve the trust index of the FESP. The trust index retrieval request may include one or more of the following parameters. The trust index retrieval request may include the identifier of the TIASCP. The trust index retrieval request may include the identifier of the FESP. The trust index retrieval request may include the ServiceID and the ServiceOperationType included in the service operation request from the User/Device to the TIASCP. Both parameters may be needed if the trust index being requested is dependent on or should be calculated/determined differently for different ServiceID and/or ServiceOperationType.

The TMF may look up or (re)calculate or (re)determine the trust index of the FESP based on the information in the trust index retrieval request. The TMF may send a response message 560 (e.g. trust index retrieval response) that includes the trust index of the FESP to the TIASCP.

The TIASCP may authenticate the FESP according to its trust index 565. For example, if its trust index is above a threshold value or within a trust index range or beyond a trust index range, the TIASCP may regard or consider the FESP as a trustable entity and may forward the service operation request to the FESP (see 570). The TIASCP may actively request the FESP's credential from the FESP and verify its credential. The FESP may be trusted if (e.g. only if) its credential is valid and its trust index is above a threshold value or within a trust index range or beyond a trust index range. If the authentication fails, the TIASCP may select another FESP and perform the actions in 555-565 again. If the authentication for another FESP fails again, the TIASCP may generate a service operation response and include a reason, for example “No Trustable FESP Found”, to the User/Device and the procedure may stop (i.e. all other actions in 570-590 may be skipped).

The TIASCP may forward the service operation request 570, received from the User/Device, to the FESP. This service operation request may be included with one or more of the following additional parameters: the identifier of the TIASCP; the trust index of the TIASCP; the credential of the TIASCP; the identifier of a the TMF from which the trust index of the TIASCP may be retrieved; the UTI and/or the DTI as received from the TMF; the identifier of this request (i.e., ReqID) (as determined in 540); a timer (e.g. OperationResponseTimer) or time period indicating that the FESP needs to or should send a service operation response to the TIASCP before the timer expires.

The identifier of the User/Device may be removed and not be included in the forwarded service operation request.

After forwarding the service operation request, the TIASCP may send an immediate response to the User/Device if the User/Device indicated a need for the immediate response in the service operation request to the TIASCP and before the timer (e.g. ImmediateResponseTimer) expires. The immediate response may include a message such as “The service operation request has been successfully forwarded to FESP at time T1”. T1 may be the time the service operation request was forwarded.

If the User/Device does not receive the immediate response before ImmediateResponseTimer or time period expires, the User/Device may regard or consider that the TIASCP has not received or has not processed the service operation request. The User/Device may send a failure message (e.g., “User/Device at location L1 did not receive the immediate response from the TIASCP after ImmediateResponseTimer expires”) to the TMF. L1 is the current location of User/Device The failure message may include the service operation request. The TMF may receive the failure message and recalculate the trust index of the TIASCP (e.g., decrease it) according to the failure message. The TMF may send a response to the User/Device indicating the receipt of the failure message and/or the recalculated trust index of the TIASCP. The TMF may also send the recalculated trust index of the TIASCP to the TIASCP and/or other entities that have subscribed to the trust index of the TIASCP.

After successfully receiving the immediate response, the User/Device may send a success message (e.g., “User/Device receives the immediate response from TIASCP at time T1 at location L1”) to the TMF. T1 may be the time of receiving the subscription response and L1 may be the current location of the User/Device. The success message may include the service operation message. The TMF may recalculate the trust index of the TIASCP (e.g., increase it) according to the success message. The TMF may send a response to the User/Device indicating the receipt of the success message and/or the recalculated trust index of the TIASCP. The TMF may also send the recalculated trust index of the TIASCP to the TIASCP and/or other entities that have subscribed to the trust index of TIASCP.

The FESP may receive the forwarded service operation request from the TIASCP and may authenticate the TIASCP considering its trust index along with its credential 575. If the trust index of the TIASCP was not included in the service operation request from the TIASCP, the FESP may retrieve its trust index from a TMF (e.g., the TMF indicated in service operation request). As an example, if the TIASCP's credential is valid and its trust index is above a threshold value, the FESP may mark or consider the TIASCP as a trustable entity and may continue to process the received service operation request.

The FESP may authenticate the received service operation request 580 considering or based on the UTI and DTI, which may be included in the request. For example, if the UTI and/or DTI is above a threshold value or within a trust index range or beyond a trust index range, the service operation request may be permitted. If the authentication fails, the execution of the requested service operation 585 may be skipped and a service operation response 590 may include a reason such as “Service Operation Request Authentication Failed”.

The FESP may execute the target service as requested in the service operation request and generate service results 585.

The FESP may generate and send a service operation response message to the TIASCP 590. The service operation response message may include the ReqID and the service results and the identifier of the FESP. The TIASCP may use the ReqID to identify the original service operation request from the User/Device to the TIASCP and the corresponding User/Device. The TIASCP may forward the service results to the corresponding User/Device 590.

If the TIASCP does not receive the service operation response before the OperationResponseTimer or time period expires, the TIASCP may regard or consider that the FESP has not received or has not processed the service operation request sent from the TIASCP. The TIASCP may send a failure message (e.g., “TIASCP did not receive the service operation response from FESP after OperationResponseTimer expires”) to the TMF. The failure message may include the service operation request. The TMF may receive the failure message and recalculate the trust index of the FESP (e.g., decrease it) according to or based on the failure message. The TMF may send a response message to the TIASCP indicating the receipt of the failure message and/or the recalculated trust index of the FESP. The TMF may also send the recalculated trust index of the FESP to the FESP and/or other entities that have subscribed to the trust index of FESP.

After successfully receiving the service operation response, the TIASCP may send a success message (e.g., “TIASCP receives the service operation response from FESP at time T1”) to the TMF. T1 may be the time of receiving the service operation response. The success message may include the service operation request. The TMF may recalculate the trust index of the FESP (e.g., increase it) according to or based on the success message. The TMF may send a response message to the TIASCP indicating the receipt of the success message and/or the recalculated trust index of the FESP. The TMF may also send the recalculated trust index of the FESP to the FESP and/or other entities that have subscribed to the trust index of FESP.

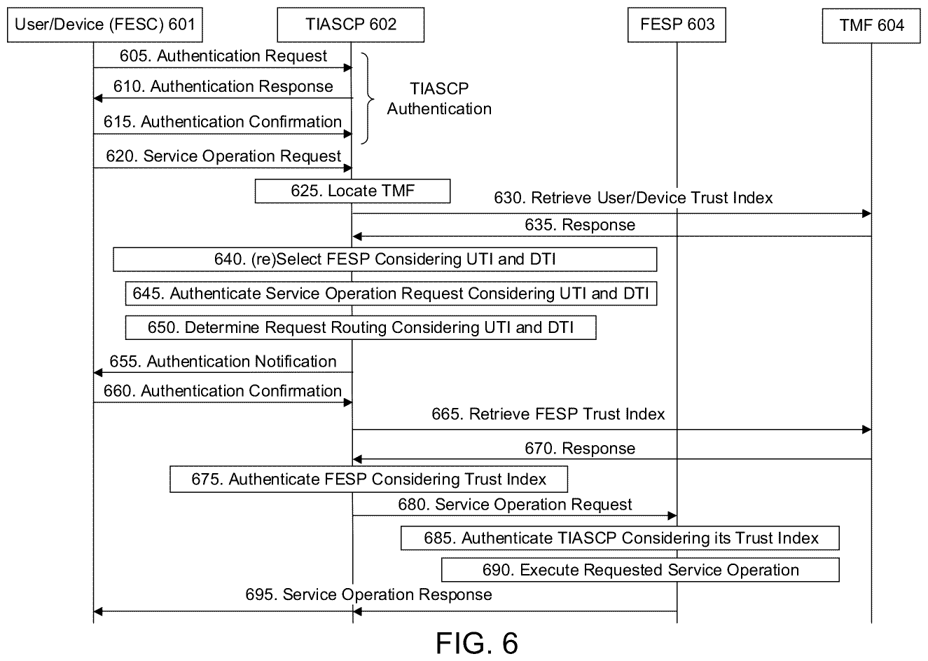

On behalf of an FESP, a TIASCP may authenticate a service operation request received from a User/Device. FIG. 6 shows a Dynamic Trust-based Authentication (DTA) for Request/Response-based Indirect Service Interaction with a TIASCP, where the TIASCP authenticates a service operation request on behalf of the FESP. As shown in FIG. 6, a TIASCP may (re) select an FESP for a Use/Device. The TIASCP may authenticate a service operation request based on their trust index on behalf of an FESP. The TIASCP may determine how to route/forward the service operation request to the FESP again considering the trust index of the User/Device.

A User/Device 601 may discover or may be provisioned or preconfigured with a TIASCP 602. The User/Device may send a message (e.g. an authentication request message) 605 to the TIASCP for the purpose of authenticating the TIASCP. The authentication request message may comprise one or more of the following parameters. The authentication request message may comprise an identifier of the User and/or the identifier of the Device. The authentication request message may comprise an indication or information that indicates that the TIASCP needs to or should send its trust index back to the User/Device (e.g. TIASCPAuthInfo=“TrustIndex”). The authentication request message may comprise the trust index of the User (UTI) and/or the trust index of the Device (DTI). The UTI and the DTI may be optional. If the UTI and the DTI are included in the authentication request message, the TIASCP may skip retrieving the UTI and DTI from the TMF (see 630 and 635). The authentication request message may comprise credentials of the User/Device.

The TIASCP may receive the authentication request from the User/Device. The TIASCP may process the authentication request and send an authentication response message 610 to the User/Device. For example, the TIASCP may authenticate the authentication request based on the credentials of the User/Device. If the credentials are valid, the TIASCP may continue to process the authentication request. If the credentials are not valid, the TIASCP may stop processing the authentication request and send a rejection indication in the authentication response message to the User/Device. If TIASCPAuthInfo=“TrustIndex” was indicated in the authentication request message and if the TIASCP does not have its trust index, the TIASCP may send a request message to a TMF and receive its trust index from the TMF. If the UTI and/or the DTI were included in the authentication request message, the TIASCP may authenticate and authorize the User/Device considering the UTI and the DTI. For example, if the UTI is above a UTI threshold value and the DTI is above a DTI threshold value, the TIASCP may regard or consider the User/Device trustable and may permit the User/Device to use its communication proxy service (e.g., send a service operation request; see 620). The TIASCP may generate an authentication response, which may include, for example: 1) the trust index of the TIASCP; 2) the credential(s) of the TIASCP; 3) the identifier of the TIASCP; and/or 4) if the User/Device is permitted to use the TIASCP's services. The TIASCP may send the authentication response message to the User/Device.

The User/Device may receive the TIASCP authentication response. The User/Device may use the trust index of the TIASCP, and optionally together with its credential, to authenticate and authorize the TIASCP. For example, if the trust index of the TIASCP is above a threshold value and/or if its credential is valid, the User/Device may regard or consider the TIASCP is trustable and may continue to use its services (e.g., send a service operation request; see 620). The User/Device may send an authentication confirmation message 615 to the TIASCP indicating if the TIASCP has been successfully authenticated and authorized. In the authentication confirmation message, the User/Device may indicate that the TIASCP later only needs to determine how to route/forward a service operation request to the FESP (see 635), and leave the authentication of service operation request to be done to the FESP. The actions performed in 605-615 may be considered TIASCP authentication. Once the actions in 605-615 have been performed and the TIASCP has been authenticated, the actions in 620-695 may be repeated multiple times without performing the actions in 605-615 again (i.e. TIASCP authentication).

The User/Device may send a service operation request message 620 to the TIASCP. The service operation request may comprise one or more of the following parameters. The service operation request may comprise the identifier of the User and/or the identifier of the Device. The service operation request may comprise the credentials of the User/Device. The service operation request may comprise the trust index of the User (UTI) and/or the trust index of the Device (DTI), signed by a TMF. This parameter may be optional. The service operation request may comprise an identifier of a TMF from which the UTI and DTI may be retrieved (e.g. TMFID). This parameter may be optional. The service operation request may comprise an identifier or a name of target services the User/Device wants or requests to access from the FESP (e.g. ServiceID). The service operation request may comprise a type of requested service operation on the target services as denoted by the ServiceID (e.g. ServiceOperationType). The service operation request may comprise an identifier of the FESP (e.g. FESPID). This parameter may be optional. If the FESPID is not included, a FESPType will be needed. The service operation request may comprise a type of FESP (e.g. FESPType). Using this parameter and/or ServiceID, the TIASCP may select a trustable FESP and forward the service operation request to the selected FESP. The service operation request may comprise an indication (e.g. ImmediateResponseFlag) that the TIASCP needs to or should send an immediate response to the User/Device (after sending the service operation request to the FESP) and before an ImmediateResponseTimer expires. The service operation request may comprise a timer (e.g. ImmediateResponseTimer) or a time period indicating that the TIASCP needs to or should send an immediate response to the User/Device after the action performed in 514 and before this timer or time period expires.

The TIASCP may locate or select (or reselect) 625 a TMF 604, from which the TIASCP may retrieve or verify the UTI/DTI. For example, the TIASCP may send a request message comprising the identifiers of the User/Device to a repository function (e.g., NRF). The repository function may search its local TMF repository against the identifiers of the User/Device to find an appropriate TMFs which may calculate/determine and expose a trust index of the User/Device. The repository function may send one or multiple founded TMFs to the TIASCP. In an example, the TIASCP may have been provisioned or preconfigured with a list of TMFs, from which the TIASCP may choose one that may calculate/determine and expose a trust index of the User/Device. If a TMFID is included in the service operation request from the User/Device to the TIASCP, the TIASCP may use the TMF as denoted by the TMFID.

The TIASCP may send a trust index retrieval request message to the determined or identified TMF 630. The trust index retrieval request may comprise an identifier of the User (e.g. UserID), an identifier of the Device (e.g. DevID), an identifier of the TIASCP (e.g. TIASCPID), ServiceID, FESPType, and/or the credential of the TIASCP.

The TMF may recalculate the UTI and/or DTI according to the parameters included in the trust index retrieval request and send a trust index retrieval response 635 to the TIASCP comprising the latest UTI and DTI. In an example, If the UTI and DTI were included in the service operation request from the User/Device to the TIASCP, the TIASCP may include the UTI/DTI in the trust index retrieval request and request the TMF to verify the UTI/DTI. The TMF may receive the UTI/DTI and verify both parameters. Then the TMF may not include the UTI/DTI in the trust index retrieval response to the TIASCP, but indicate if both parameters are valid or invalid. In another example, if the UTI and DTI and the TMF's signature on both were included in the service operation request from the User/Device to the TIASCP, the TIASCP may be able to directly verify the UTI and DTI by verifying the TMF's signature without contacting the TMF.

The TIASCP may (re) select an FESP for serving the service operation request received from the User/Device. The TIASCP may use similar approaches as shown in in 540 of FIG. 5. For example, the TIASCP may receive the trust index retrieval response. The TIASC may continue to process the service operation request 640. If the FESPID was not included in the service operation request from the User/Device to the TIASCP, the TIASCP may select an appropriate FESP, for example, according to or based on the FESPType, ServiceID, UTI, and/or DTI. For example, the UTI and DTI should meet the selected FESP's requirement on user trust index and device trust index. Based on the received UTI and DTI, the TIASCP may determine how to forward or route the service operation request from the User/Device to the TIASCP to the selected FESP. As an example, if the UTI and/or DTI is below a threshold value, the TIASCP may reject the service operation request from the User/Device to the TIASCP. Then, it may send a rejection notification message to the User/Device and the procedure may stop. In another example, if the UTI and/or DTI is above a threshold value, the TIASCP may agree to forward the service operation request to the selected FESP. If the UTI and/or DTI is below a threshold value or within a trust index range or beyond a trust index range, the TIASCP may select a FESP with a capability of performing dynamic trust-based authentication (DTA). In another example, the TIASCP may forward the service operation request from the Users/Devices with close UTI/DTI to the same FESP. In another example, if the UTI/DTI is below a threshold value or within a trust index range or beyond a trust index range, the TIASCP may not reject the service operation request, but determine to buffer it for a period of time. The period of time may be adjusted when the UTI/DTI changes (e.g. increases or decreases). Then, the TIASCP may request the TMF to monitor the trust index of the User/Device and send any updated UTI/DTI to the TIASCP. For each permitted service operation request, the TIASCP may assign a unique identifier (e.g. ReqID), which may be generated based on the identifier of the User, the identifier of the Device, the identifier of the TIASCP, the time when the service operation request was received by the TIASCP, a sequence number, and/or a random number.

The TIASCP may authenticate the service operation request 645 from the User/Device on behalf of a FESP 603. The TIASCP may use similar approaches as in 580 of FIG. 5. For example, the TIASCP may authenticate the received service operation request considering the UTI and DTI, which may be included in the request. For example, if the UTI and/or DTI is above a threshold value or within a trust index range or beyond a trust index range, the service operation request may be permitted. If the authentication fails, the execution of the requested service operation may be skipped and a service operation response may include a reason such as “Service Operation Request Authentication Failed”.

Before authenticating the service operation request (e.g. performing actions in 645), the TIASCP may send a notification message to the FESP to inform the FESP that there is a service operation request to be forwarded to the FESP. The TIASCP may also ask or request if the FESP wants the TIASCP to authenticate the service operation request and based on which authentication policy (e.g., DTA based on the trust index of User/Device). The FESP may check/determine if the TIASCP is trustable enough (e.g., based on the TIASCP's trust index). The FESP may send a confirmation message to the TIASCP indicating that the TIASCP needs to should authenticate the service operation request and the corresponding authentication policy (e.g., one or more trust index thresholds or one or more trust index ranges) to be used, for example, if the TIASCP has a high trust index.

Before receiving the service operation request from the User/Device, the TIASCP and the FESP may have authenticated each other. As a result, the FESP may have provisioned some authentication policies (e.g., DTA based on the trust index of the User/Device, one or more trust index thresholds or one or more trust index ranges) to the TIASCP. For authenticating the service operation request 645, the TIASCP may simply use and enforce the provisioned authentication policy to the service operation request.

The TIASCP may receive the trust index retrieval response. The TIASCP may continue to process the service operation request 650. If the FESPID was not included in the service operation request from the User/Device to the TIASCP, the TIASCP may select an appropriate FESP, for example, according to or based on the FESPType, ServiceID, UTI, and/or DTI. For example, the UTI and DTI should meet the selected FESP's requirement on user trust index and device trust index. Based on the received UTI and DTI, the TIASCP may determine how to forward or route the service operation request from the User/Device to the TIASCP to the selected FESP. As an example, if the UTI and/or DTI is below a threshold value, the TIASCP may reject the service operation request from the User/Device to the TIASCP. Then, it may send a rejection notification message to the User/Device and the procedure may stop. In another example, if the UTI and/or DTI is above a threshold value, the TIASCP may agree to forward the service operation request to the selected FESP. If the UTI and/or DTI is not high enough, the TIASCP may select a FESP with a capability of performing dynamic trust-based authentication (DTA). In another example, the TIASCP may forward the service operation request from the Users/Devices with close UTI/DTI to the same FESP. In another example, if the UTI/DTI is below a threshold, the TIASCP may not reject the service operation request, but determine to buffer it for a period of time. The period of time may be adjusted when the UTI/DTI changes (e.g. increases or decreases). Then, the TIASCP may request the TMF to monitor the trust index of the User/Device and send any updated UTI/DTI to the TIASCP. For each permitted service operation request, the TIASCP may assign a unique identifier (e.g. ReqID), which may be generated based on the identifier of the User, the identifier of the Device, the identifier of the TIASCP, the time when the service operation request was received by the TIASCP, a sequence number, and/or a random number.

The TIASCP may send an authentication notification message 655 to the User/Device. The authentication notification may inform the User/Device what has been determined in 650 including the selected FESP (e.g. whether the service operation request is accepted, rejected, or buffered). The authentication notification may also include information regarding the trust index retrieval response. If a new TMF was selected, the TMFID of the new TMF may also be included in the authentication notification. This authentication notification may also include the result of the authentication (see 645). ReqID may be included in the authentication notification message 545. The trust index of the TIASCP may be included in the authentication notification message. The authentication notification message may include a buffering period that the TIASCP may have determined in 645 for buffering the service operation request for a time duration as denoted by the buffering period.

The User/Device may receive and store the authentication notification and send an authentication confirmation message 660 to the TIASCP. Using the authentication confirmation, the User/Device may indicate its agreement or disagreement with what is included in the authentication notification. For example, if the service operation request was determined to be buffered, the User/Device may indicate to cancel the service operation request (e.g., include ReqID in the authentication confirmation message and indicate “cancellation”), for example, if the trust index of the TIASCP is below a threshold value and/or the determined buffering period is higher than a threshold value. In this case, the procedure may be stopped and the TIASC may remove the service operation request from its local storage. Before forwarding the service operation request to the selected FESP, the TIASCP may need to perform dynamic trust-based authentication (DTA) over the selected FESP (see 665-675). For example, when it takes a longer time for the TIASCP to receive the last service operation request from the FESP, the TIASCP may perform such trust-based authentication for the FESP. In another example, when the FESP was selected for the first time, the TIASCP may also perform such trust-based authentication for the FESP.

The TIASCP may send a request message (i.e. trust index retrieval request) 665 to the TMF to retrieve the trust index of the FESP. The trust index retrieval request may include one or more of the following parameters. The trust index retrieval request may include the identifier of the TIASCP. The trust index retrieval request may include the identifier of the FESP. The trust index retrieval request may include the ServiceID and the ServiceOperationType included in the service operation request from the User/Device to the TIASCP. Both parameters may be needed if the trust index being requested is dependent on or should be calculated/determined differently for different ServiceID and/or ServiceOperationType.

The TMF may look up or (re)calculate or (re)determine the trust index of the FESP based on the information in the trust index retrieval request. The TMF may send a response message (e.g. trust index retrieval response) 670 that includes the trust index of the FESP to the TIASCP.

The TIASCP may authenticate the FESP according to or based on its (FESP) trust index 675. For example, if its trust index is above a threshold value, the TIASCP may regard or consider the FESP as a trustable entity and may forward the service operation request to the FESP (see 680). The TIASCP may actively request the FESP's credential from the FESP and verify its credential. The FESP may be trusted if (e.g. only if) its credential is valid and its trust index is above a threshold value. If the authentication fails, the TIASCP may select another FESP and perform the actions in 665-675 again. If the authentication for another FESP fails again, the TIASCP may generate a service operation response and include a reason, for example “No Trustable FESP Found”, to the User/Device and the procedure may stop (i.e. all other actions in 680-695 may be skipped).

The TIASCP may forward the service operation request 680, received from the User/Device, to the FESP. This service operation request may be included with one or more of the following additional parameters: the identifier of the TIASCP; the trust index of the TIASCP; the credential of the TIASCP; the identifier of a the TMF from which the trust index of the TIASCP may be retrieved; the UTI and/or the DTI as received from the TMF; the identifier of this request (i.e., ReqID) (as determined in 645 or 650); a timer (e.g. OperationResponseTimer) or time period indicating that the FESP needs to or should send a service operation response to the TIASCP before the timer expires.

The identifier of the User/Device may be removed and not be included in the forwarded service operation request.

After forwarding the service operation request, the TIASCP may send an immediate response to the User/Device if the User/Device indicated a need for the immediate response in the service operation request to the TIASCP and before the timer (e.g. ImmediateResponseTimer) expires. The immediate response may include a message such as “The service operation request has been successfully forwarded to FESP at time T1”. T1 may be the time the service operation request was forwarded.

If the User/Device does not receive the immediate response before ImmediateResponseTimer or time period expires, the User/Device may regard or consider that the TIASCP has not received or has not processed the service operation request. The User/Device may send a failure message (e.g., “User/Device at location L1 did not receive the immediate response from the TIASCP after ImmediateResponseTimer expires”) to the TMF. L1 may be the current location of User/Device. The failure message may include the service operation request. The TMF may receive the failure message and recalculate the trust index of the TIASCP (e.g., decrease it) according to or based on the failure message. The TMF may send a response to the User/Device indicating the receipt of the failure message and/or the recalculated trust index of the TIASCP. The TMF may also send the recalculated trust index of the TIASCP to the TIASCP and/or other entities that have subscribed to the trust index of the TIASCP.

After successfully receiving the immediate response, the User/Device may send a success message (e.g., “User/Device receives the immediate response from TIASCP at time T1 at location L1”) to the TMF. T1 may be the time of receiving the subscription response and L1 may be the current location of the User/Device. The success message may include the service operation request. The TMF may recalculate the trust index of the TIASCP (e.g., increase it) according to or based on the success message. The TMF may send a response to the User/Device indicating the receipt of the success message and/or the recalculated trust index of the TIASCP. The TMF may also send the recalculated trust index of the TIASCP to the TIASCP and/or other entities that have subscribed to the trust index of TIASCP

The FESP may receive the forwarded service operation request from the TIASCP and may authenticate the TIASCP considering its trust index along with its credential 685. If the trust index of the TIASCP was not included in the service operation request from the TIASCP, the FESP may retrieve its trust index from a TMF (e.g., the TMF indicated in service operation request). As an example, if the TIASCP's credential is valid and its trust index is above a threshold value or within a trust index range or beyond a trust index range, the FESP may mark or consider the TIASCP as a trustable entity and may continue to process the received service operation request.

The FESP may start to execute the target service as requested in the service operation request and generate service results 690.

The FESP may send a service operation response message 695 to the TIASCP. The service operation response message may include the ReqID and the service results. The TIASCP may use the ReqID to identify the original service operation request from the User/Device to the TIASCP and the corresponding User/Device. The TIASCP may forward the service results 695 to the corresponding User/Device.

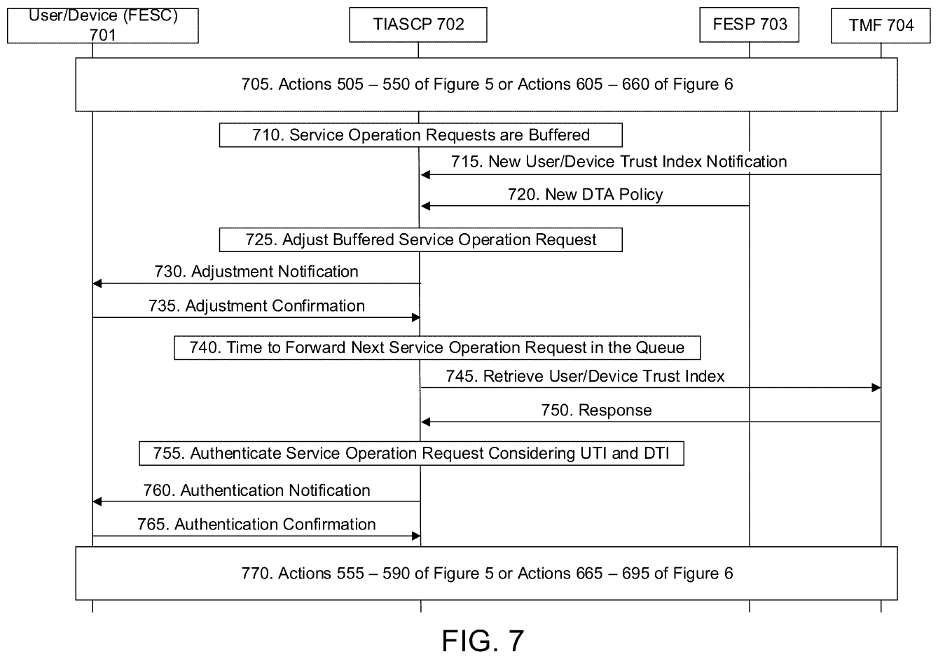

In an embodiment, a TIASCP may dynamically authenticate buffered service operation requests. FIG. 7 shows an example procedure for Dynamic Trust-based Authentication (DTA) for a Request/Response-based Indirect Service Interaction with a TIASCP, where the TIASCP dynamically authenticates buffered service operation requests

After a TIASCP receives a service operation request from a User/Device, it may buffer the request for a period of time (i.e., a buffering period) for a particular reason (e.g., requested by the User/Device, an FESP is currently not available, the trust index of the User/Device is below a threshold, the service operation request has a low priority compared to other requests from other Users/Devices, or the TIASCP cannot process the request immediately due to limited communication capability to FESP). When a service operation request is buffered and before it is forwarded by the TIASCP to a FESP, the trust index of User/Device may change (e.g. decrease or increase). As a result, the TIASCP may need to re-authenticate the buffered service operation request according to the varying trust index of the User/Device (i.e., the sender of buffered service operation requests) and adjust how the request will be forwarded from the TIASCP to the FESP (e.g., a buffered service operation request may be forwarded earlier to the FESP, a buffered service operation request may be buffered longer, a buffered service operation request may be removed). The FESP may send new DTA policies (e.g., trust index thresholds or trust index ranges that the trust index of User/Device may need to or should meet) to the TIASCP, which may need to be enforced on the buffered service operation request.

The procedure shown in FIG. 7 may take place between the actions of 660 and 665 of FIG. 6. The procedure shown in FIG. 7 also may take place between the actions of 550 and 555 of FIG. 5.

The actions of 505 through 550 of FIG. 5 or the actions of 605 through 660 of FIG. 6 may take place 705.

A TIASCP 702 may buffer one or more service operation requests, 710 which may be received from a User/Device 701 and other FESCs.

The TIASCP may receive a notification message 715 (e.g. new User/Device Trust Index notification) from a TMF 704 (or other FEs) comprising a new User/Device trust index (i.e., New-UTI, New-DTI) 702. This notification may comprise a list of identifiers of Users/Devices (or other FESCs) and their new trust index. This action is optional. This notification may comprise a list of FESPs 703 and their new trust index (FESPTI).

The FESP 703 may send some new DTA policies 720 to the TIASCP. For example, a new DTA policy may increase (or decrease) the threshold of trust index, based on which User/Device and its service operation request may be regarded as trustable. This action may be optional. The sending of the new DTA policies by the FESP may occur before the TMF sends a notification message 715 comprising a new User/Device trust index.

Based on the new trust index received by the TIASCP from the TMF (i.e., UTI, DTI, and/or FESPTI) and/or new DTA policies received by the TIASCP from the FESP, the TIASCP may adjust 725 how buffered service operation requests of the User/Device will be served and forwarded to the FESP. The TIASCP may use the same approach as in 640-650 of FIG. 6. For example, if the trust index of a selected FESP is below a threshold value, the service operation requests that are supposed to be forwarded to the FESP may be buffered for a longer time such as until the trust index of the FESP becomes greater than the threshold value. For example, if the trust index of a User/Device decreases (e.g., below a pre-configured trust index threshold value or the new trust index threshold contained in new DTA policies), the TIASCP may deprioritize the User/Device's service operation requests (e.g., remove the User/Device's service operation requests, increase the period of time for buffering the User/Device's service operation requests, or move the User/Device's service operation requests toward the tail of the queue of all buffered service operation requests). In another example, if the trust index of the User/Device increases (e.g., above a pre-configured trust index threshold value or the new trust index threshold contained in new DTA policies), the TIASCP may prioritize the User/Device's service operation requests (e.g., decrease the period of time for buffering the User/Device's service operation requests, or move the User/Device's service operation requests toward the head of the queue of all buffered service operation requests). The TIASCP may also reselect a new FESP for each buffered service operation request, for example, if a previously selected FESP has a decreased trust index.

The TIASCP may send an adjustment notification message 730 to the User/Device (and other FESCs) to inform them of the adjustments made by the TIASCP and the reason for such adjustments. The identifier of any adjusted or impacted service operations requests of the User/Device may be included in the adjustment notification. The identifier of the reselected new FESPs may optionally be included in the adjustment notification.

The User/Device may receive and store the adjustment notification message and send an adjustment confirmation message 735 to the TIASCP. The User/Device may use the adjustment confirmation to request cancellation of one or multiple buffered service operation requests, especially if they were deprioritized by the TIASCP. For example, if a buffered service operation request needs to be buffered for an increased time as determined by the TIASCP, the User/Device may cancel this service operation request by indicating the identifier of this request in the adjustment confirmation message and a “cancellation” indication. As a result, the TIASCP may remove this request from its buffer.

When it is the time to serve and forward a next service operation request (e.g., the head of the queue of all buffered service operation request) of a User/Device, the TIASCP may need to re-perform DTA on the User/Device and this service operation request since the trust index of the User/Device may have been changed 740.

The TIASCP may retrieve the latest trust index of the User/Device from a TMF. For example, the TIASCP may send a trust index retrieval request message 745 to the determined or identified TMF. The trust index retrieval request may comprise an identifier of the User (e.g. UserID), an identifier of the Device (e.g. DevID), an identifier of the TIASCP (e.g. TIASCPID), ServiceID and/or FESPType contained in the service operation request, and/or the credential of the TIASCP. The TMF may recalculate UTI and DTI according to or based on the parameters included in the trust index retrieval message, and send a trust index retrieval response 750 to the TIASCP comprising the latest UTI and DTI. In an example, If the UTI and DTI were included in the service operation request from the User/Device to the TIASCP, the TIASCP may include the UTI/DTI in the trust index retrieval request and request the TMF to verify the UTI/DTI. The TMF may receive the UTI/DTI and verify both parameters. Then the TMF may not include the UTI/DTI in the trust index retrieval response to the TIASCP, but indicate if both parameters are valid or invalid. In another example, if the UTI and DTI and the TMF's signature on both were included in the service operation request from the User/Device to the TIASCP, the TIASCP may be able to directly verify the UTI and DTI by verifying the TMF's signature without contacting the TMF.

The TIASCP may authenticate the service operation request 755 based on the new trust index of User/Device. For example the TIASCP may perform actions as in 645 of FIG. 6. The TIASCP may make similar adjustments as described in 725 of FIG. 7. Even if the actions in 725 were performed, the actions in 755 may still be needed.

The TIASCP may send an authentication notification message 760 to the User/Device. For example, the TIASCP may send the authentication notification message similar to 655 in FIG. 6. The authentication notification may inform the User/Device what has been determined in 755 including the selected FESP (e.g. whether the service operation request is accepted, rejected, or buffered). The authentication notification may also include information regarding the trust index retrieval response. If a new TMF was selected, the TMFID of the new TMF may also be included in the authentication notification. This authentication notification may also include the result of the authentication (see 645). ReqID may be included in the authentication notification message. The trust index of the TIASCP may be included in the authentication notification message. The authentication notification message may include a buffering period that the TIASCP may have determined for buffering the service operation request for a time duration as denoted by the buffering period.

The User/Device may receive and store the authentication notification and send an authentication confirmation message 765 to the TIASCP. Using the authentication confirmation, the User/Device may indicate its agreement or disagreement with what is included in the authentication notification. For example, the User/Device may send the authentication confirmation similar to 660 in FIG. 6.

The actions of 555 through 590 of FIG. 5 or the actions of 665 through 695 FIG. 6 may take place 770.

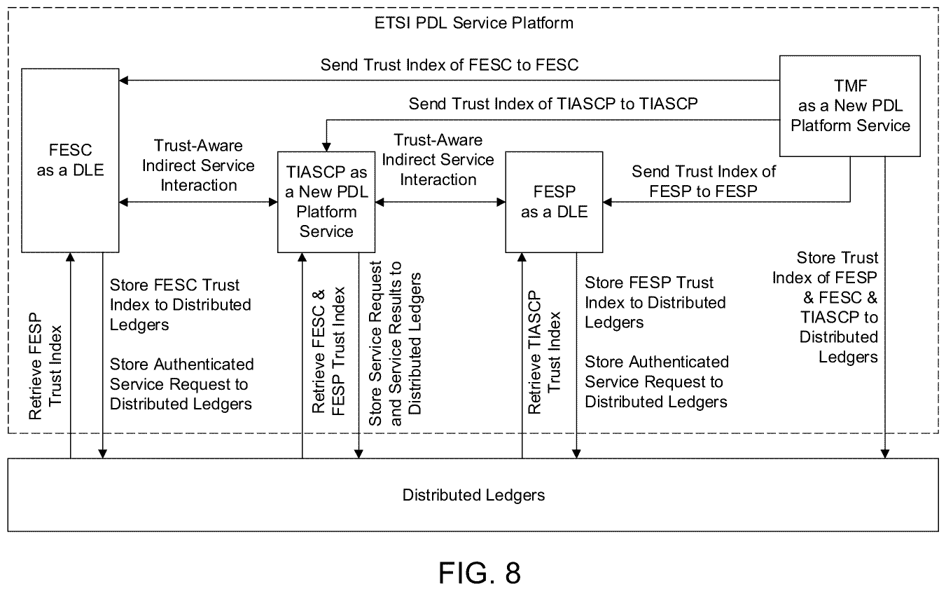

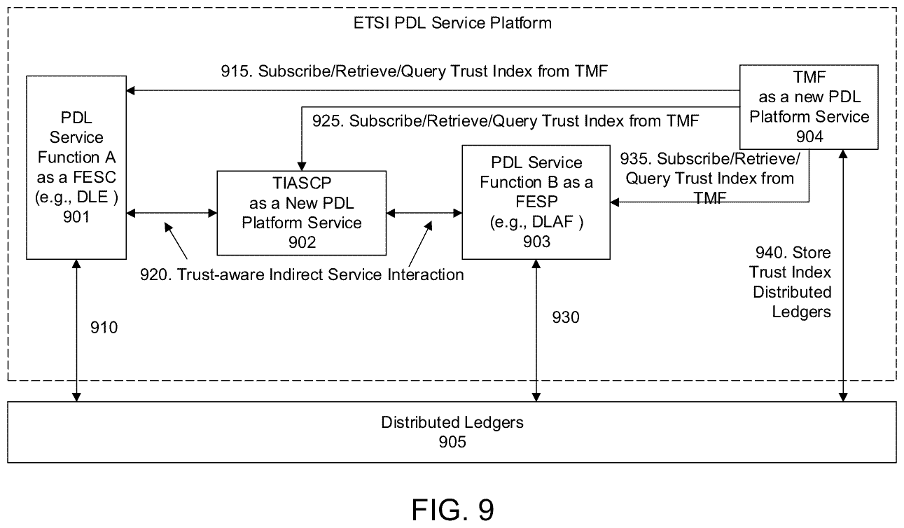

Following the permissioned distributed ledger (PDL) service architecture in ETSI GS PDL-024, the embodiments in FIGS. 5, 6, and 7 may be implemented in a PDL embodiment, as shown in FIGS. 8 and 9.

FIG. 8 shows an example procedure for ETSI PDL for TIASCP-based Indirect Service Interaction. An FESC may be implemented as a Distributed Ledger Enabler (DLE) node such as a DLE-Client. Alternatively, the FESC may have an embedded DLE or interact with an external DLE. The FESC may rely on a DLE to interface to a PDL service platform.

An FESP may be implemented as a DLE node such as a DLE-Peer. Alternatively, the FESP may have an embedded DLE or interact with an external DLE. The FESP may rely on a DLE to interface to a PDL service platform.

A TMF may be implemented as a new PDL platform service, which may be accessed by an FESC (as a DLE) and an FESP (as a DLE). The TMF may record or store the calculated or determined trust index of the FESCs and FESPs including a TMF's signature to one or more distributed ledgers. Alternatively, a FESC (or a FESP) may retrieve its trust index from a TMF and then store its trust index to one or more distributed ledgers.

A TIASCP may be implemented as a new PDL platform service.

When authenticating a service operation request from a FESC, the TIASCP may retrieve the trust index of a FESC from one or more distributed ledgers, or a TMF. The TIASCP may subscribe to one or more distributed ledgers (e.g., via a DLE-Peer) to receive automatic notifications about a FESC's trust index from one or more distributed ledgers. After the service operation request is successfully authenticated considering the trust index, the TIASCP may record or store the request and/or corresponding service results to one or more distributed ledgers.

When authenticating a FESP, the TIASCP may retrieve the trust index of a FESP from one or more distributed ledgers, or a TMF. The TIASCP may subscribe to one or more distributed ledgers (e.g., via a DLE-Peer) to receive automatic notifications about a FESP's trust index from one or more distributed ledgers. After the FESP is successfully authenticated considering its trust index, the TIASCP may record or store the request and/or corresponding service results to one or more distributed ledgers.

As shown in FIG. 8, a FESC as a DLE may retrieve a TIASCP trust index and/or a FESP trust index from a distributed ledger (DL). The FESC as a DLE may store its trust index to a DL. The FESC as a DLE may store an authenticated service request to a DL. The FESC as a DLE may receive a trust index of the FESC from the TMF. The FESC as a DLE may perform a trust-aware indirect service interaction with an TIASCP.

As shown in FIG. 8, a TIASCP may retrieve a FESC and a FESP trust index from a DL. The TIASCP may store a service request and service results to a DL. The TIASCP may receive a trust index of the TIASCP from the TMF. The TIASCP may perform a trust-aware indirect service interaction with the FESP as a DLE.

As shown in FIG. 8, the FESP as a DLE may retrieve a TIASCP trust index from a DL. The FESP as a DLE may store a FESP trust index to a DL. The FESP as a DLE may store an authenticated service request to a DL. The FESP as a DLE may perform a trust-aware indirect service interaction with the TIASCP.

As shown in FIG. 8, the TMF may send a trust index of the FESC to the FESC. The TMF may send a trust index of the TIASCP to the TIASCP. The TMF may send a trust index of the FESP to the FESP. The TMF may store a trust index of the FESP and the FESC and the TIASCP to a DL.

FIG. 9 shows PDL service interactions based on a TIASCP. In an embodiment, shown in FIG. 9, PDL service functions (e.g., DLE, DLAF, DLRF, Distributed Ledger Data Storage Management (DLDSM), and Distributed Ledger Governance Function (DLGF)), for example as defined in ETSI GS PDL-02, may leverage the embodiments in FIGS. 5, 6, and 7 to enhance their interaction with each other. When a PDL service function A requests/accesses/uses services provided by another PDL service function B, the PDL service function A may be a FESC while the PDL service function B may be a FESP. A TIASCP may be a new PDL service function. When the PDL service function A needs or request to access services from the PDL service function B, the PDL service function A as a FESC may use the procedures for example as shown in FIGS. 5, 6, and/or 7 to first contact a TIASCP. The TIASCP may use the same procedures as shown in FIGS. 5, 6, and/or 7 to talk or communicate with the PDL service function B as a FESP. The TMF may be a new PDL service function.

In FIG. 9, a PDL service function A 901 may interact 910 with a DL 905. PDL service function A 901 may subscribe/retrieve/query a trust index 915 from a TMF 904. PDL service function A 901 may perform a trust-aware indirect service interaction 920 with a TIASCP 902.

In FIG. 9, a TIASCP as a new PDL service platform 902 may perform a trust-aware indirect service interaction 920 with a PDL service function A (e.g. as a FESC, DLE) 901 and a PDL service function B (e.g. as a FESP, DLAF) 903. The TIASCP 902 may subscribe/retrieve/query a trust index 925 from the TMF 904.

In FIG. 9, the PDL service function B (e.g. as a FESP, DLAF) 903 may interact 930 with a DL 905. PDL service function B 903 may subscribe/retrieve/query 935 a trust index from the TMF 904. PDL service function B may perform a trust-aware indirect service interaction 920 with the TIASCP 902.

In FIG. 9, the TMF 904 may store a trust index 940 to a DL 905. The TMF 904 may send a trust index 935 to PDL service function B 903. The TMF 904 may send a trust index 915 to PDL service function A 901. The TMF 904 may send a trust index 925 to the TIASCP 902. The trust index stored on a DL 905 may be retrieved directly by PDL service function A, TIASCP, and/or PDL service function B, from the DL.

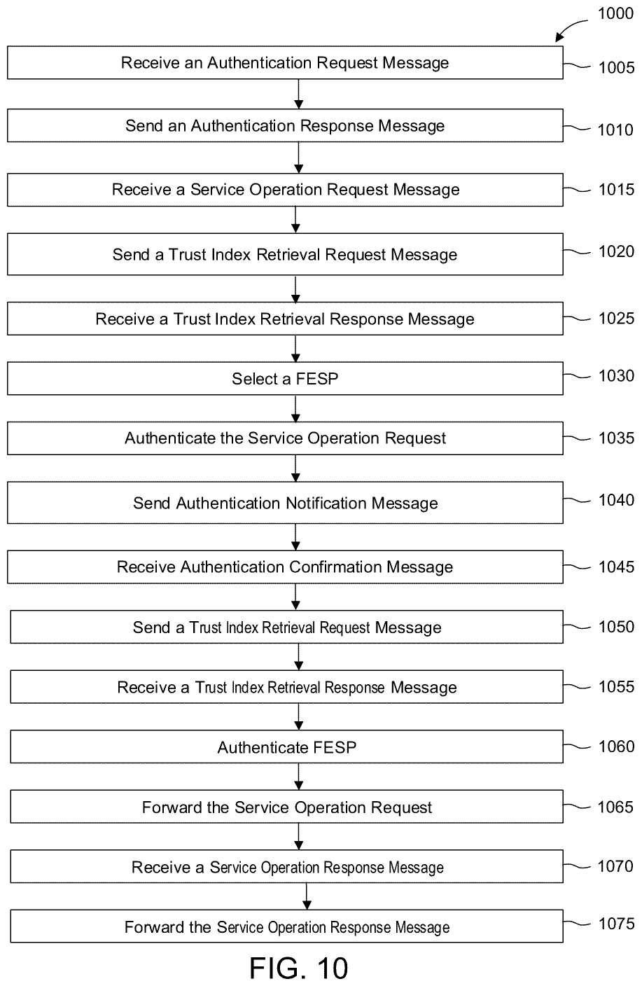

FIG. 10 shows a method 1000 for Dynamic Trust-based Authentication (DTA) for a Request/Response-based Indirect Service Interaction.

A first node may receive an authentication request message from a second node requesting a trust index of the first node 1005. The first node may be a TIASCP. The second node may be a User/Device. The second node may be a FESC. The authentication request message may comprise one or more of the following parameters. The authentication request message may comprise an identifier of the User/Device. For example, the identifier of the User/Device may be an identifier of the User and/or the identifier of the Device. The authentication request message may comprise an indication or information that indicates that the TIASCP needs to or should send its trust index back to the User/Device (e.g. TIASCPAuthInfo=“TrustIndex”). The authentication request message may comprise the trust index of the User (UTI) and/or the trust index of the Device (DTI). The UTI and the DTI may be optional. If the UTI and the DTI are included in the first request message, the TIASCP may skip retrieving the UTI and DTI from a TMF. The authentication request message may comprise credentials of the User/Device.

The TIASCP may send an authentication response message to the User/Device 1010. The authentication response message may indicate the trust index of the TIASCP. The TIASCP may authenticate the authentication request message based on the credentials of the User/Device. If the credentials are valid, the TIASCP may continue to process the authentication request message. If the credentials are not valid, the TIASCP may stop processing the authentication request message and send a rejection indication in the authentication response message to the User/Device. If TIASCPAuthInfo=“TrustIndex” was indicated in the authentication request message and if the TIASCP does not have its trust index, the TIASCP may send a request message to a TMF and receive its trust index from the TMF. If the UTI and/or the DTI were included in the authentication request message, the TIASCP may authenticate and authorize the second node considering the UTI and the DTI. For example, if the UTI is above a UTI threshold value and the DTI is above a DTI threshold value, the TIASCP may regard or consider the second node as trustable and may permit the User/Device to use its communication proxy service (e.g., send a service operation request). The TIASCP may generate an authentication response, which may include, for example: 1) the trust index of the TIASCP; 2) the credential(s) of the TIASCP; 3) the identifier of the TIASCP; and/or 4) if the User/Device is permitted to use the TIASCP's services. The TIASCP may send the authentication response message to the User/Device. The TIASCP may receive an authentication confirmation message from the User/Device indicating if the TIASCP has been successfully authenticated and authorized.

The TIASCP may receive a service operation request message from the User/Device 1015. The service operation request may comprise one or more of the following parameters. The service operation request may comprise the identifier of the User and/or the identifier of the Device. The service operation request may comprise the credentials of the User/Device. The service operation request may comprise the trust index of the User (UTI) and/or the trust index of the Device (DTI), signed by a TMF. This parameter may be optional. The service operation request may comprise an identifier of a TMF from which the UTI and DTI may be retrieved (e.g. TMFID). This parameter may be optional. The service operation request may comprise an identifier or a name of target services the User/Device wants or requests to access from the FESP (e.g. ServiceID). The service operation request may comprise a type of requested service operation on the target services as denoted by the ServiceID (e.g. ServiceOperationType). The service operation request may comprise an identifier of an FESP (e.g. FESPID). This parameter may be optional. If the FESPID is not included, a FESPType will be needed. The service operation request may comprise a type of FESP (e.g. FESPType). Using this parameter, the TIASCP may select a trustable FESP and forward the service operation request to the selected FESP. The service operation request may comprise an indication (e.g. ImmediateResponseFlag) that the TIASCP needs to or should send an immediate response to the User/Device (after sending the service operation request to the FESP) and before an ImmediateResponseTimer expires. The service operation request may comprise a timer (e.g. ImmediateResponseTimer) or a time period indicating that the TIASCP needs to or should send an immediate response to the User/before this timer or time period expires.

The TIASCP may send a trust index retrieval request message to a third node (e.g. a TMF) to retrieve the trust index of the User/Device 1020. The trust index retrieval request may comprise an identifier of the User (e.g. UserID), an identifier of the Device (e.g. DevID), ServiceID, FESPType, FESPID, an identifier of the TIASCP (e.g. TIASCPID), and/or the credential of the TIASCP. The TIASCP may select (or reselect) the TMF, from which to send the trust index retrieval request message. For example, the TIASCP may send a request message comprising the identifiers of the User/Device to a repository function (e.g., NRF). The repository function may search its local TMF repository against the identifiers of the User/Device to find an appropriate TMFs which may calculate/determine and expose a trust index of the User/Device. The repository function may send one or multiple founded TMFs to the TIASCP. In an example, the TIASCP may have been provisioned or preconfigured with a list of TMFs, from which the TIASCP may choose one that may calculate/determine and expose a trust index of the User/Device. If a TMFID is included in the service operation request from the User/Device to the TIASCP, the TIASCP may use the TMF as denoted by the TMFID.

The TIASCP may receive a trust index retrieval response message from the TMF that comprises the trust index of the User/Device 1025. The trust index of the User/Device may be a latest UTI and/or DTI. In an example, If the UTI and DTI were included in the service operation request from the User/Device to the TIASCP, the TIASCP may include the UTI/DTI in the trust index retrieval request and request the TMF to verify the UTI/DTI. The TMF may receive the UTI/DTI and verify both parameters. Then the TMF may not include the UTI/DTI in the trust index retrieval response to the TIASCP, but indicate if both parameters are valid or invalid. In another example, if the UTI and DTI and the TMF's signature on both were included in the service operation request from the User/Device to the TIASCP, the TIASCP may be able to directly verify the UTI and DTI by verifying the TMF's signature without contacting the TMF.

The TIASCP may select a node as the service producer (e.g. FESP) for the User/Device according to the trust index of the User/Device 1030. If an FESPID was not included in the service operation request from the User/Device to the TIASCP, the TIASCP may select an appropriate FESP, for example, according to or based on the FESPType, ServiceID, UTI, and/or DTI. For example, the UTI and DTI should meet the selected FESP's requirement on user trust index and device trust index.

The TIASCP may authenticate the service operation request based on the trust index of the User/Device 1035. Based on the received UTI and DTI, the TIASCP may determine how to forward or route the service operation request from the User/Device to the TIASCP to the selected FESP. As an example, if the UTI and/or DTI is below a threshold value, the TIASCP may reject the service operation request from the User/Device to the TIASCP. Then, it may send a rejection notification message to the User/Device and the procedure may stop. In another example, if the UTI and/or DTI is above a threshold value, the TIASCP may agree to forward the service operation request to the selected FESP. If the UTI and/or DTI is not high enough, the TIASCP may select a FESP with a capability of performing dynamic trust-based authentication (DTA). In another example, the TIASCP may forward the service operation request from the Users/Devices with close UTI/DTI to the same FESP. In another example, if the UTI/DTI is too low, the TIASCP may not reject the service operation request, but determine to buffer it for a period of time. The period of time may be adjusted when the UTI/DTI changes (e.g. increases or decreases). Then, the TIASCP may request the TMF to monitor the trust index of the User/Device and send any updated UTI/DTI to the TIASCP. For each permitted service operation request, the TIASCP may assign a unique identifier (e.g. ReqID), which may be generated based on the identifier of the User, the identifier of the Device, the identifier of the TIASCP, the time when the service operation requested was received by the TIASCP, a sequence number, and/or a random number.

The TIASCP may send an authentication notification message to the User/Device 1040. The authentication notification may inform the User/Device regarding the selected FESP and whether the service operation request is accepted, rejected, or buffered. The authentication notification may also include a ReqID. The authentication notification may also include information regarding the trust index retrieval response. If a new TMF was selected, the TMFID of the new TMF may also be included in the authentication notification.

The TIASCP may receive an authentication confirmation message from the User/Device 1045. The authentication confirmation message may include the User/Device's agreement or disagreement with what is included in the authentication notification. For example, if the service operation request was determined to be buffered, the User/Device may indicate to cancel the service operation request. In this case, the procedure may be stopped and the TIASC may remove the service operation request from its local storage. Before forwarding the service operation request to the selected FESP, the TIASCP may need to perform dynamic trust-based authentication (DTA) over the selected FESP. For example, when it takes a longer time for the TIASCP to receive the last service operation request from the FESP, the TIASCP may perform such trust-based authentication for the FESP. In another example, when the FESP was selected for the first time, the TIASCP may also perform such trust-based authentication for the FESP.

The TIASCP may send a trust index retrieval request message to the TMF to retrieve the trust index of the FESP 1050. The trust index retrieval request may include one or more of the following parameters. The trust index retrieval request may include the identifier of the TIASCP. The trust index retrieval request may include the identifier of the FESP. The trust index retrieval request may include the ServiceID and the ServiceOperationType included in the service operation request from the User/Device to the TIASCP. Both parameters may be needed if the trust index being requested is dependent on or should be calculated/determined differently for different ServiceID and/or ServiceOperationType.

The TIASCP may receive a trust index retrieval response message from the TFM that includes the trust index of the FESP 1055.

The TIASCP may authenticate the FESP based on the trust index of the FESP 1060. For example, if the trust index is above a threshold value, the TIASCP may regard or consider the FESP as a trustable entity and may forward the service operation request to the FESP. The TIASCP may actively request the FESP's credential from the FESP and verify its credential. The FESP may be trusted if (e.g. only if) its credential is valid and its trust index is above a threshold value. If the authentication fails, the TIASCP may select another FESP. If the authentication for another FESP fails again, the TIASCP may generate a service operation response and include a reason, for example “No Trustable FESP Found”, to the User/Device.

The TIASCP may send/forward the service operation request to the FESP 1065. This service operation request may be modified with and sent with one or more of the following additional parameters: the identifier of the TIASCP; the trust index of the TIASCP; the credential of the TIASCP; the identifier of the TMF from which the trust index of the TIASCP may be retrieved; the UTI and/or the DTI as received from the TMF; the identifier of this request (i.e., ReqID); a timer (e.g. OperationResponseTimer) or time period indicating that the FESP needs to or should send a service operation response to the TIASCP before the timer expires. The identifier of the User/Device may be removed and not be included in the forwarded service operation request.

After sending the service operation request, the TIASCP may send an immediate response to the User/Device if the User/Device indicated a need for the immediate response in the service operation request to the TIASCP and before the timer (e.g. ImmediateResponseTimer) expires. The immediate response may include a message such as “The service operation request has been successfully forwarded to FESP at time T1”. T1 may be the time the service operation request was forwarded.

The TIASCP may receive a service operation response message from the FESP 1070. The service operation response message may include the ReqID and service results. The TIASCP may use the ReqID to identify the original service operation request from the User/Device to the TIASCP and the corresponding User/Device.

The TIASCP may forward the service operation response in a service operation response message to the User/Device 1075.

If the TIASCP does not receive the service operation response before the OperationResponseTimer or time period expires, the TIASCP may regard or consider that the FESP has not received or has not processed the service operation request sent from the TIASCP. The TIASCP may send a failure message (e.g., “TIASCP did not receive the service operation response from FESP after OperationResponseTimer expires”) to the TMF. The failure message may include the service operation request. The TMF may receive the failure message and recalculate the trust index of the FESP (e.g., decrease it) according to or based on the failure message. The TMF may send a response message to the TIASCP indicating the receipt of the failure message and/or the recalculated trust index of the FESP. The TMF may also send the recalculated trust index of the FESP to the FESP and/or other entities that have subscribed to the trust index of FESP.

After successfully receiving the service operation response, the TIASCP may send a success message (e.g., “TIASCP receives the service operation response from FESP at time T1”) to the TMF. T1 may be the time of receiving the service operation response. The failure message may include the service operation request. The TMF may recalculate the trust index of the FESP (e.g., increase it) according to or based on the success message. The TMF may send a response message to the TIASCP indicating the receipt of the success message and/or the recalculated trust index of the FESP. The TMF may also send the recalculated trust index of the FESP to the FESP and/or other entities that have subscribed to the trust index of FESP.

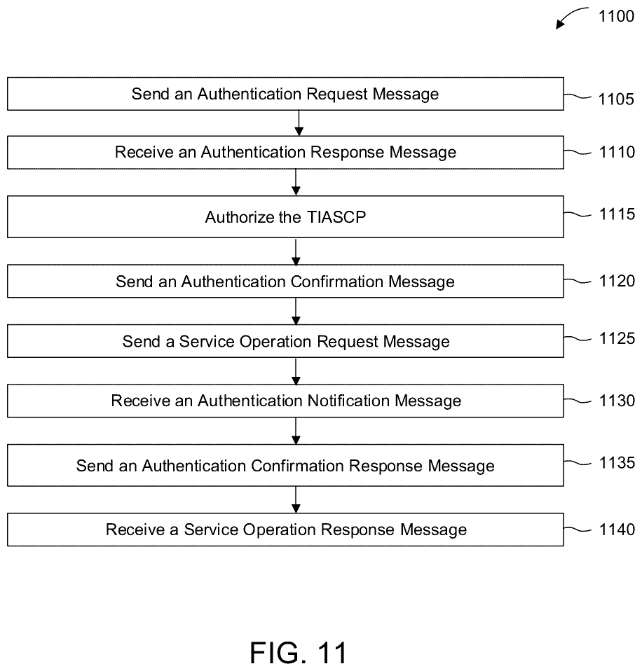

FIG. 11 shows a method 1100 for Dynamic Trust-based Authentication (DTA) for a Request/Response-based Indirect Service Interaction.

A first node may send an authentication request message to a second node requesting a trust index of the first node 1105. The first node may be a User/Device. The first node may be a FESC. The second node may be a TIASCP. The authentication request message may comprise one or more of the following parameters. The authentication request message may comprise an identifier of the User/Device. For example, the identifier of the User/Device may be an identifier of the User and/or the identifier of the Device. The authentication request message may comprise an indication or information that indicates that the TIASCP needs to or should send its trust index back to the User/Device (e.g. TIASCPAuthInfo=“TrustIndex”). The authentication request message may comprise the trust index of the User (UTI) and/or the trust index of the Device (DTI). The UTI and the DTI may be optional. If the UTI and the DTI are included in the first request message, the TIASCP may skip retrieving the UTI and DTI from a TMF. The authentication request message may comprise credentials of the User/Device. The User/Device may discover or may be provisioned or preconfigured with a TIASCP. The authentication request message may be send for the purpose of authenticating the TIASCP.

The User/Device may receive an authentication response message from the TIASCP 1110. The authentication response message may indicate the trust index of the TIASCP. The TIASCP may authenticate the authentication request message based on the credentials of the User/Device. If the credentials are valid, the TIASCP may continue to process the authentication request message. If the credentials are not valid, the TIASCP may stop processing the authentication request message and send a rejection indication in the authentication response message to the User/Device. If TIASCPAuthInfo=“TrustIndex” was indicated in the authentication request message and if the TIASCP does not have its trust index, the TIASCP may send a request message to a TMF and receive its trust index from the TMF. If the UTI and/or the DTI were included in the authentication request message, the TIASCP may authenticate and authorize the second node considering the UTI and the DTI. For example, if the UTI is above a UTI threshold value and the DTI is above a DTI threshold value, the TIASCP may regard or consider the second node as trustable and may permit the User/Device to use its communication proxy service (e.g., send a service operation request). The authentication response message may include, for example: 1) the trust index of the TIASCP; 2) the credential(s) of the TIASCP; 3) the identifier of the TIASCP; and/or 4) if the User/Device is permitted to use the TIASCP's services.

The User/Device may authorize the TIASCP 1115. The User/Device may use the trust index of the TIASCP, and optionally together with its credential, to authenticate and authorize the TIASCP. For example, if the trust index of the TIASCP is above a threshold value and/or if its credential is valid, the User/Device may regard or consider the TIASCP is trustable and may continue to use its services (e.g., send a service operation request).

The User/Device may send an authentication confirmation message to the TIASCP 1120. The authentication confirmation message may indicate if the TIASCP has been successfully authenticated and authorized. In the authentication confirmation message, the User/Device may indicate that the TIASCP later only needs to determine how to route/forward a service operation request to the FESP, and leave the authentication of service operation request to be done to the FESP.

The User/Device may send a service operation request message to the TIASCP 1125. The service operation request may comprise one or more of the following parameters. The service operation request may comprise the identifier of the User and/or the identifier of the Device. The service operation request may comprise the credentials of the User/Device. The service operation request may comprise the trust index of the User (UTI) and/or the trust index of the Device (DTI), signed by a TMF. This parameter may be optional. The service operation request may comprise an identifier of a TMF from which the UTI and DTI may be retrieved (e.g. TMFID). This parameter may be optional. The service operation request may comprise an identifier or a name of target services the User/Device wants or requests to access from the FESP (e.g. ServiceID). The service operation request may comprise a type of requested service operation on the target services as denoted by the ServiceID (e.g. ServiceOperationType). The service operation request may comprise an identifier of the FESP (e.g. FESPID). This parameter may be optional. If the FESPID is not included, a FESPType will be needed. The service operation request may comprise a type of FESP (e.g. FESPType). Using this parameter, the TIASCP may select a trustable FESP and forward the service operation request to the selected FESP (see 514). The service operation request may comprise an indication (e.g. ImmediateResponseFlag) that the TIASCP needs to or should send an immediate response to the User/Device (after sending the service operation request to the FESP) and before an ImmediateResponseTimer expires. The service operation request may comprise a timer (e.g. ImmediateResponseTimer) or a time period indicating that the TIASCP needs to or should send an immediate response to the User/Device before this timer or time period expires.

The User/Device may receive an authentication notification message from the TIASCP 1130. The authentication notification may inform the User/Device regarding the selected FESP and whether the service operation request is accepted, rejected, or buffered. The authentication notification may include the identifier of the service operation request (i.e., ReqID), which the TIASCP determined. The authentication notification may also include information regarding the trust index retrieval response. If a new TMF was selected, the TMFID of the new TMF may also be included in the authentication notification.

The User/Device may send an authentication confirmation response message to the TIASCP 1135. Using the authentication confirmation response, the User/Device may indicate its agreement or disagreement with what is included in the authentication notification. For example, if the service operation request was determined to be buffered, the User/Device may indicate to cancel the service operation request.

The TIASCP may forward the service operation request to the FESP. The TIASCP may send and the User/Device may receive an immediate response if the User/Device indicated a need for the immediate response in the service operation request to the TIASCP and before the timer (e.g. ImmediateResponseTimer) expires. The immediate response may include a message such as “The service operation request has been successfully forwarded to FESP at time T1”. T1 may be the time the service operation request was forwarded.

If the User/Device does not receive the immediate response before ImmediateResponseTimer or time period expires, the User/Device may regard or consider that the TIASCP has not received or has not processed the service operation request. The User/Device may send a failure message (e.g., “User/Device did not receive the immediate response from the TIASCP after ImmediateResponseTimer expires”) to a TMF. The failure message may include the service operation request. The TMF may receive the failure message and recalculate the trust index of the TIASCP (e.g., decrease it) according to or based on the failure message. The TMF may send a response to the User/Device indicating the receipt of the failure message and/or the recalculated trust index of the TIASCP. The TMF may also send the recalculated trust index of the TIASCP to the TIASCP and/or other entities that have subscribed to the trust index of the TIASCP.

After successfully receiving the immediate response, the User/Device may send a success message (e.g., “User/Device receives the immediate response from TIASCP at time T1 at location L1”) to the TMF. T1 may be the time of receiving the subscription response and L1 may be the current location of the User/Device. The success message may include the service operation request. The TMF may recalculate the trust index of the TIASCP (e.g., increase it) according to or based on the success message. The TMF may send a response to the User/Device indicating the receipt of the success message and/or the recalculated trust index of the TIASCP. The TMF may also send the recalculated trust index of the TIASCP to the TIASCP and/or other entities that have subscribed to the trust index of TIASCP.

The User/Device may receive a service operation response message from the TIASCP 1140. The service operation response message may include the ReqID and service results.

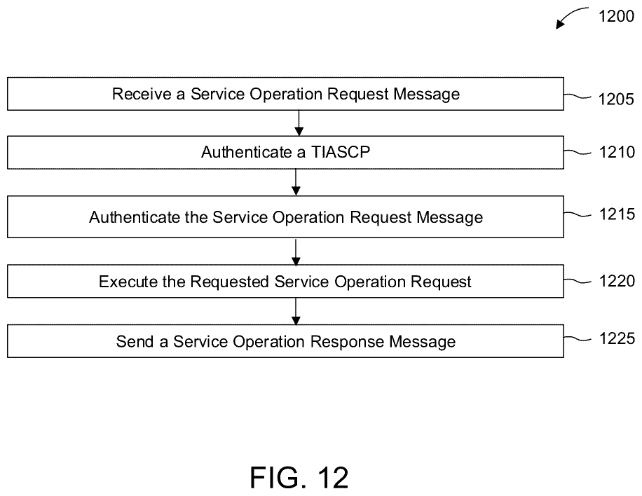

FIG. 12 shows a method 1200 for Dynamic Trust-based Authentication (DTA) for a Request/Response-based Indirect Service Interaction.

A first node may receive a service operation request message from a second node 1205. The first node may be a service producer (e.g. FESP). The second node may be a TIASCP. The service operation request may be forwarded by the TIASCP from or for a third node (e.g. User/Device, service consumer, FESC).

The service operation request message may comprise one or more of the following parameters. The service operation request may comprise an identifier of the User and/or the identifier of the Device. The service operation request may comprise the credentials of the User/Device. The service operation request may comprise a trust index of the User (UTI) and/or a trust index of the Device (DTI), signed by a TMF. This parameter may be optional. The service operation request may comprise an identifier of a TMF from which the UTI and DTI may be retrieved (e.g. TMFID). This parameter may be optional. The service operation request may comprise an identifier or a name of target services the User/Device wants or requests to access from the FESP (e.g. ServiceID). The service operation request may comprise a type of requested service operation on the target services as denoted by the ServiceID (e.g. ServiceOperationType). The service operation request may comprise an identifier of the FESP (e.g. FESPID). This parameter may be optional. If the FESPID is not included, a FESPType will be needed. The service operation request may comprise a type of FESP (e.g. FESPType). Using this parameter, the TIASCP may select a trustable FESP and forward the service operation request to the selected FESP. The service operation request may comprise an indication (e.g. ImmediateResponseFlag) that the TIASCP needs to or should send an immediate response to the User/Device (after sending the service operation request to the FESP) and before an ImmediateResponseTimer expires. The service operation request may comprise a timer (e.g. ImmediateResponseTimer) or a time period indicating that the TIASCP needs to or should send an immediate response to the User/Device before this timer or time period expires. This service operation request may also include one or more of the following additional parameters: the identifier of the TIASCP; the trust index of the TIASCP; the credential of the TIASCP; the identifier of a the TMF from which the trust index of the TIASCP may be retrieved; the UTI and/or the DTI as received from the TMF; the identifier of this request (i.e., ReqID); a timer (e.g. OperationResponseTimer) or time period indicating that the FESP needs to or should send a service operation response to the TIASCP before the timer expires.

The FESP may authenticate the TIASCP 1210. The FESP may authenticate the TIASCP considering or based on the TIASCP trust index along with the TIASCP credential. If the trust index of the TIASCP was not included in the service operation request from the TIASCP, the FESP may retrieve its trust index from a TMF (e.g., the TMF indicated in the service operation request). As an example, if the TIASCP's credential is valid and its trust index is above a threshold value, the FESP may mark or consider the TIASCP as a trustable entity and may continue to process the received service operation request.

The FESP may authenticate the received service operation request 1215. The FESP may authenticate the received service operation request considering or based on the UTI and DTI, which may be included in the request. For example, if the UTI and/or DTI is above a threshold value, the service operation request may be permitted. If the authentication fails, the execution of the requested service operation may be skipped and a service operation response may include a reason such as “Service Operation Request Authentication Failed”.

The FESP may execute the target service as requested in the service operation request and generate service results 1220.

The FESP may send a service operation response message to the TIASCP 1225. The service operation response message may include the ReqID and the service results. The TIASCP may use the ReqID to identify the original service operation request from the User/Device to the TIASCP and the corresponding User/Device. The TIASCP may forward the service results to the corresponding User/Device.

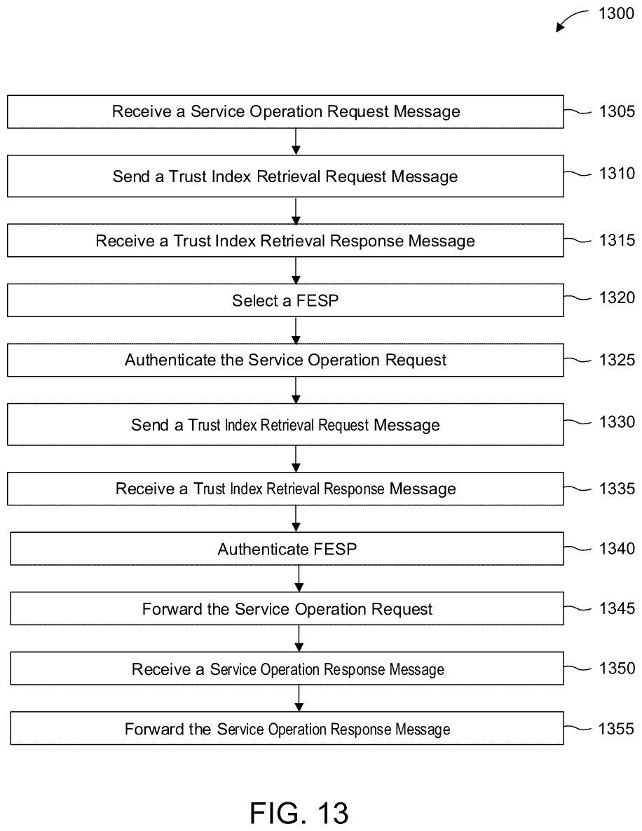

FIG. 13 shows a method 1300 for Dynamic Trust-based Authentication (DTA) for a Request/Response-based Indirect Service Interaction.

A first node (e.g. a TIASCP) may receive a service operation request message from a second node (e.g. a User/Device or FESC) 1305. The first node may be a TIASCP. The second node may be a User/Device. The second node may be a FESC. The service operation request may comprise one or more of the following parameters. The service operation request may comprise the identifier of the User and/or the identifier of the Device. The service operation request may comprise the credentials of the User/Device. The service operation request may comprise the trust index of the User (UTI) and/or the trust index of the Device (DTI), signed by a TMF. This parameter may be optional. The service operation request may comprise an identifier of a TMF from which the UTI and DTI may be retrieved (e.g. TMFID). This parameter may be optional. The service operation request may comprise an identifier or a name of target services the User/Device wants or requests to access from the FESP (e.g. ServiceID). The service operation request may comprise a type of requested service operation on the target services as denoted by the ServiceID (e.g. ServiceOperationType). The service operation request may comprise an identifier of an FESP (e.g. FESPID). This parameter may be optional. If the FESPID is not included, a FESPType will be needed. The service operation request may comprise a type of FESP (e.g. FESPType). Using this parameter, the TIASCP may select a trustable FESP and forward the service operation request to the selected FESP. The service operation request may comprise an indication (e.g. ImmediateResponseFlag) that the TIASCP needs to or should send an immediate response to the User/Device (after sending the service operation request to the FESP) and before an ImmediateResponseTimer expires. The service operation request may comprise a timer (e.g. ImmediateResponseTimer) or a time period indicating that the TIASCP needs to or should send an immediate response to the User/before this timer or time period expires.

Prior to receiving the service operation request, or afterwards, the TIASCP may receive an authentication request message from the User/Device (or FESC) requesting a trust index of the first node. The authentication request message may comprise one or more of the following parameters. The authentication request message may comprise an identifier of the User/Device. For example, the identifier of the User/Device may be an identifier of the User and/or the identifier of the Device. The authentication request message may comprise an indication or information that indicates that the TIASCP needs to or should send its trust index back to the User/Device (e.g. TIASCPAuthInfo=“TrustIndex”). The authentication request message may comprise the trust index of the User (UTI) and/or the trust index of the Device (DTI). The UTI and the DTI may be optional. If the UTI and the DTI are included in the first request message, the TIASCP may skip retrieving the UTI and DTI from a TMF. The authentication request message may comprise credentials of the User/Device.

The TIASCP may send an authentication response message to the User/Device. The authentication response message may indicate the trust index of the TIASCP. The TIASCP may authenticate the authentication request message based on the credentials of the User/Device. If the credentials are valid, the TIASCP may continue to process the authentication request message. If the credentials are not valid, the TIASCP may stop processing the authentication request message and send a rejection indication in the authentication response message to the User/Device. If TIASCPAuthInfo=“TrustIndex” was indicated in the authentication request message and if the TIASCP does not have its trust index, the TIASCP may send a request message to a TMF and receive its trust index from the TMF. If the UTI and/or the DTI were included in the authentication request message, the TIASCP may authenticate and authorize the second node considering the UTI and the DTI. For example, if the UTI is above a UTI threshold value and the DTI is above a DTI threshold value, the TIASCP may regard or consider the second node as trustable and may permit the User/Device to use its communication proxy service (e.g., send a service operation request). The TIASCP may generate an authentication response, which may include, for example: 1) the trust index of the TIASCP; 2) the credential(s) of the TIASCP; 3) the identifier of the TIASCP; and/or 4) if the User/Device is permitted to use the TIASCP's services. The TIASCP may send the authentication response message to the User/Device. The TIASCP may receive an authentication confirmation message from the User/Device indicating if the TIASCP has been successfully authenticated and authorized.

The TIASCP may send a trust index retrieval request message to a third node (e.g. a TMF) to retrieve the trust index of the User/Device 1310. The trust index retrieval request may comprise an identifier of the User (e.g. UserID), an identifier of the Device (e.g. DevID), ServiceID, FESPType, FESPID, an identifier of the TIASCP (e.g. TIASCPID), and/or the credential of the TIASCP. The TIASCP may select (or reselect) the TMF, from which to send the trust index retrieval request message. For example, the TIASCP may send a request message comprising the identifiers of the User/Device to a repository function (e.g., NRF). The repository function may search its local TMF repository against the identifiers of the User/Device to find an appropriate TMFs which may calculate/determine and expose a trust index of the User/Device. The repository function may send one or multiple founded TMFs to the TIASCP. In an example, the TIASCP may have been provisioned or preconfigured with a list of TMFs, from which the TIASCP may choose one that may calculate/determine and expose a trust index of the User/Device. If a TMFID is included in the service operation request from the User/Device to the TIASCP, the TIASCP may use the TMF as denoted by the TMFID.

The TIASCP may receive a trust index retrieval response message from the TMF that comprises the trust index of the User/Device 1315. The trust index of the User/Device may be a latest UTI and/or DTI. In an example, If the UTI and DTI were included in the service operation request from the User/Device to the TIASCP, the TIASCP may include the UTI/DTI in the trust index retrieval request and request the TMF to verify the UTI/DTI. The TMF may receive the UTI/DTI and verify both parameters. Then the TMF may not include the UTI/DTI in the trust index retrieval response to the TIASCP, but indicate if both parameters are valid or invalid. In another example, if the UTI and DTI and the TMF's signature on both were included in the service operation request from the User/Device to the TIASCP, the TIASCP may be able to directly verify the UTI and DTI by verifying the TMF's signature without contacting the TMF.

The TIASCP may select a node as the service producer (e.g. FESP) for the User/Device according to the trust index of the User/Device 1320. If an FESPID was not included in the service operation request from the User/Device to the TIASCP, the TIASCP may select an appropriate FESP, for example, according to or based on the FESPType, ServiceID, UTI, and/or DTI. For example, the UTI and DTI should meet the selected FESP's requirement on user trust index and device trust index.

The TIASCP may authenticate the service operation request based on the trust index of the User/Device 1325. Based on the received UTI and DTI, the TIASCP may determine how to forward or route the service operation request from the User/Device to the TIASCP to the selected FESP. As an example, if the UTI and/or DTI is below a threshold value, the TIASCP may reject the service operation request from the User/Device to the TIASCP. Then, it may send a rejection notification message to the User/Device and the procedure may stop. In another example, if the UTI and/or DTI is above a threshold value, the TIASCP may agree to forward the service operation request to the selected FESP. If the UTI and/or DTI is not high enough, the TIASCP may select a FESP with a capability of performing dynamic trust-based authentication (DTA). In another example, the TIASCP may forward the service operation request from the Users/Devices with close UTI/DTI to the same FESP. In another example, if the UTI/DTI is too low, the TIASCP may not reject the service operation request, but determine to buffer it for a period of time. The period of time may be adjusted when the UTI/DTI changes (e.g. increases or decreases). Then, the TIASCP may request the TMF to monitor the trust index of the User/Device and send any updated UTI/DTI to the TIASCP. For each permitted service operation request, the TIASCP may assign a unique identifier (e.g. ReqID), which may be generated based on the identifier of the User, the identifier of the Device, the identifier of the TIASCP, the time when the service operation requested was received by the TIASCP, a sequence number, and/or a random number.

The TIASCP may send an authentication notification message to the User/Device. The authentication notification may inform the User/Device regarding the selected FESP and whether the service operation request is accepted, rejected, or buffered. The authentication notification may also include a ReqID. The authentication notification may also include information regarding the trust index retrieval response. If a new TMF was selected, the TMFID of the new TMF may also be included in the authentication notification.

The TIASCP may receive an authentication confirmation message from the User/Device. The authentication confirmation message may include the User/Device's agreement or disagreement with what is included in the authentication notification. For example, if the service operation request was determined to be buffered, the User/Device may indicate to cancel the service operation request. In this case, the procedure may be stopped and the TIASC may remove the service operation request from its local storage. Before forwarding the service operation request to the selected FESP, the TIASCP may need to perform dynamic trust-based authentication (DTA) over the selected FESP. For example, when it takes a longer time for the TIASCP to receive the last service operation request from the FESP, the TIASCP may perform such trust-based authentication for the FESP. In another example, when the FESP was selected for the first time, the TIASCP may also perform such trust-based authentication for the FESP.

The TIASCP may send a trust index retrieval request message to the TMF to retrieve the trust index of the FESP 1330. The trust index retrieval request may include one or more of the following parameters. The trust index retrieval request may include the identifier of the TIASCP. The trust index retrieval request may include the identifier of the FESP. The trust index retrieval request may include the ServiceID and the ServiceOperationType included in the service operation request from the User/Device to the TIASCP. Both parameters may be needed if the trust index being requested is dependent on or should be calculated/determined differently for different ServiceID and/or ServiceOperationType.

The TIASCP may receive a trust index retrieval response message from the TFM that includes the trust index of the FESP 1335.

The TIASCP may authenticate the FESP based on the trust index of the FESP 1340. For example, if the trust index is above a threshold value, the TIASCP may regard or consider the FESP as a trustable entity and may forward the service operation request to the FESP. The TIASCP may actively request the FESP's credential from the FESP and verify its credential. The FESP may be trusted if (e.g. only if) its credential is valid and its trust index is above a threshold value. If the authentication fails, the TIASCP may select another FESP. If the authentication for another FESP fails again, the TIASCP may generate a service operation response and include a reason, for example “No Trustable FESP Found”, to the User/Device.

The TIASCP may send/forward the service operation request to the FESP 1345. This service operation request may be modified with and sent with one or more of the following additional parameters: the identifier of the TIASCP; the trust index of the TIASCP; the credential of the TIASCP; the identifier of the TMF from which the trust index of the TIASCP may be retrieved; the UTI and/or the DTI as received from the TMF; the identifier of this request (i.e., ReqID); a timer (e.g. OperationResponseTimer) or time period indicating that the FESP needs to or should send a service operation response to the TIASCP before the timer expires. The identifier of the User/Device may be removed and not be included in the forwarded service operation request.

After sending the service operation request, the TIASCP may send an immediate response to the User/Device if the User/Device indicated a need for the immediate response in the service operation request to the TIASCP and before the timer (e.g. ImmediateResponseTimer) expires. The immediate response may include a message such as “The service operation request has been successfully forwarded to FESP at time T1”. T1 may be the time the service operation request was forwarded.

The TIASCP may receive a service operation response message from the FESP 1350. The service operation response message may include the ReqID and service results. The TIASCP may use the ReqID to identify the original service operation request from the User/Device to the TIASCP and the corresponding User/Device.

The TIASCP may forward the service operation response in a service operation response message to the User/Device 1355.

If the TIASCP does not receive the service operation response before the OperationResponseTimer or time period expires, the TIASCP may regard or consider that the FESP has not received or has not processed the service operation request sent from the TIASCP. The TIASCP may send a failure message (e.g., “TIASCP did not receive the service operation response from FESP after OperationResponseTimer expires”) to the TMF. The failure message may include the service operation request. The TMF may receive the failure message and recalculate the trust index of the FESP (e.g., decrease it) according to the failure message. The TMF may send a response message to the TIASCP indicating the receipt of the failure message and/or the recalculated trust index of the FESP. The TMF may also send the recalculated trust index of the FESP to the FESP and/or other entities that have subscribed to the trust index of FESP.

After successfully receiving the service operation response, the TIASCP may send a success message (e.g., “TIASCP receives the service operation response from FESP at time T1”) to the TMF. T1 may be the time of receiving the service operation response. The failure message may include the service operation request. The TMF may recalculate the trust index of the FESP (e.g., increase it) according to the success message. The TMF may send a response message to the TIASCP indicating the receipt of the success message and/or the recalculated trust index of the FESP. The TMF may also send the recalculated trust index of the FESP to the FESP and/or other entities that have subscribed to the trust index of FESP.

Trust covers and is beyond security. A trust index may be obtained via a trust evaluation process (e.g. conducted by a TMF). A trust index may be an overall metric, which may often be calculated based on an aggregation of one or more trust indicators using certain trust evaluation algorithms. For example, trust indicators may cover various aspects, such as security, privacy, resilience, performance, robustness, scalability, availability, accuracy, reliability, and consistency. More importantly, the criteria for evaluating trust may also be subjective, for example based on user/personal experience/preference. For example, given two entities A and B (who needs to interact with a third entity C), entities A and B may have different criteria regarding how the trust of entity C should be evaluated. For example, in case entities A and B are service consumers and entity C is a service producer, entity A and entity B may have different trust evaluation criteria regarding how to evaluate entity C's trust for providing various services. For example, entity A may care more about the security, privacy and resilience (as focused trust indicators) of entity C when entity C is providing services to entity A. In comparison, entity B may care more about a different set of trust indicators (such as availability, or residency) of entity C when entity C is providing services to entity B. Therefore, the ideas and embodiments proposed herein may have the following generalizations related to trust index. The following generalizations may be applicable to all the proposed procedures and embodiments in this disclosure, for example, all the messaging between an entity and a TMF).

In a first generalization related to trust index generation, it is proposed that: when any requesting entity (e.g. entity A, which may be an FESP or FESC as defined herein) needs to contact a TMF (e.g. sending a request to a TMF) to inquiry about a trust index of another target entity (e.g. entity C) or initiating a trust evaluation on the target entity, the TMF not only may provide the trust index of the target entity (as described herein) and return the trust index to the requesting entity (e.g. entity A), but also may return an associated explanatory information in the response. An associated explanatory information may be when the trust index was generated. For example, the trust index may be generated by a TMF ten seconds ago, which reflects the latest trust index of the target entity. An associated explanatory information may be how the trust index was generated. For example, this parameter may indicate the next level of information regarding what kinds of trust evaluation criteria has been adopted by the TMF to generate this trust index. This parameter may indicate: (i) what kinds of data were collected for trust evaluation and where the data were stored, (ii) what kinds of trust indicators were focused, (iii) what kinds of algorithms were adopted for calculating trust indicators and/or the trust index (e.g. during the trust evaluation, what kinds of collected data were used as inputs for the adopted algorithms in order to calculate the focused trust indicators and/or the overall trust index), (iv) what kinds of parameter values were set during the calculation of trust indicators or a trust index. A TMF may be pre-configured with a popular or standard suite of trust evaluation criteria, so that the TMF may conduct standard or popular trust evaluation, which may be appropriate or desired for most of requesting entities. An associated explanatory information may be the applicable scope of the trust index. It is possible that a target entity (e.g. entity C acting as a FESP) may provide different services, but the target entity may have different levels of trust when delivering those different services. For example, one service (e.g. Service X) provided by the target entity may be related to computing operations, while another service (e.g. Service Y) provided by the target entity may be related to communication operations. Therefore, it is possible that the target entity may have a high trust index for providing Service X, and at the same time, the FESP may have a low trust index for providing Service Y. Overall, in the first generalization, anytime when a TMF needs to send a trust index to a receiver (i.e. the entity A, who has sent a request to TMF for trust index inquiry or trust evaluation), the above new information elements may also be attached, along with the returned trust index value.

A second generalization related to trust index generation is that: when any requesting entity (such as entity A) sends a request to a TMF to inquiry the trust index of a target entity (such as entity C), the request may further include parameters which enable customized trust evaluation by describing how the requesting entity (e.g., entity A) prefers the TMF to conduct trust evaluation on the target entity, or how the trust index shall or should be calculated or determined. For example, in addition to whose trust index is being inquired (e.g. entity C), the following new information elements related to customized trust evaluation criteria may also be included in the request sent from entity A to the TMF. Information related to customized trust evaluation criteria may include how the trust of the target entity should be evaluated (e.g. what kinds of specific trust evaluation criteria should be adopted by TMF to generate trust index). This may include: what kinds of trust indicators should be focused, what kinds of algorithms should be adopted for calculating trust indicators and/or the trust index. Alternatively, a TMF may be pre-provisioned with different sets of trust evaluation criteria (each is identified by a trust evaluation criteria identifier). If that is the case, entity A may directly indicate the identifier of the preferred trust evaluation criteria when it sends the trust index inquiry request to the TMF. By receiving this parameter, the TMF may adopt the corresponding trust evaluation criteria preferred by the entity A when the TMF conducts a trust evaluation on the target entity (i.e. entity C) in order to generate the trust index of the target entity. Information related to customized trust evaluation criteria may include the applicable scope of the trust index. It is possible that the target entity (such as entity C) may provide different services, but the target entity may have different levels of trust when delivering those different services. For example, one service (e.g. Service X) provided by the target entity may be related to computing operations, while another service (e.g. Service Y) provided by the target entity may be related to communication operations. Therefore, this parameter is to indicate that entity A intends to inquiry the trust index of the target entity (i.e. entity C) regarding which services. For example, entity A may only want to know the trust of target entity for providing a specific (e.g. Service X). In another example, entity A may want to know the trust of target entity for providing a set of specific services (e.g. Service X, Service Y, etc.) or even all of the services provided by the target entity. Once the TMF receives this parameter, it allows the TMF to determine which data shall be collected in order to calculate the needed trust index. Information related to customized trust evaluation criteria may include that TMF may conduct the customized trust evaluation based on the above parameters sent from entity A. One a trust index is generated by the TMF, the trust index will be returned to entity A. Same as the first generalization related to trust index generation, when retuning the trust index to entity A, the TMF not only may provide the trust index value of the target entity (e.g. a numerical value or a rank), but also may return a set of explanatory information, which are the same as the parameters listed in the first generalization, such as when the trust index was generated, how the trust index was generated (e.g. the adopted trust evaluation criteria, etc.), and the applicable scope of the trust index.

The solutions proposed and embodiment herein often involve steps or actions related to a requesting entity interacting with a TMF, such as “sending” a request to a TMF for inquiring the trust index of a target entity and “receiving” a response from a TMF, in which the inquired trust index is attached or included. Such an interaction may be further generalized to “obtaining” the trust index of a target entity from the TMF. In other words, depending on how the TMF is implemented, “obtaining” the trust index of a target entity may be realized in different ways. For example, the requesting entity may communicate with the TMF via an intermediate medium, such as a distributed ledger. Also, the TMF may be implemented in different ways. For example, the TMF may be implemented as a native 3GPP function (e.g. as a new Network Function (NF) in the core network, a new function inside the access network of the 3GPP system, or implemented as an enhanced feature of an existing NF in 3GPP cellular system, such as 5G network data analytics function (NWDAF) and/or the Security Function deployed by the MNO). The TMF may also be implemented as a new ETSI PDL platform service, or the TMF may be implemented as a smart contract deployed in a distributed ledger system (in this case, the request/response will be embodied as distributed ledger transactions).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by a trust-index-aware service communication proxy (TIASCP), the method comprising:
receiving, from a function entity service consumer (FESC), a first service operation request message that comprises a service operation request;
sending, to a trust management function (TMF), a FESC trust index retrieval request message;
receiving, from the TMF, a FESC trust index retrieval response message that comprises a trust index of the FESC, wherein the trust index of the FESC comprises at least a device trust index (DTI);
selecting a function entity service provider (FESP) based on the trust index of the FESC;
authenticating the service operation request based on the trust index of the FESC;
sending, to the TMF, a FESP trust index retrieval request message;
receiving, from the TMF, a FESP trust index retrieval response message that includes a trust index of the FESP;
authenticating the FESP based on the trust index of the FESP;
forwarding, to the FESP, a modified service operation request in a second service operation request message, wherein the modified service operation request comprises an identifier of the TIASCP;
receiving, from the FESP, a service operation response message that comprises service operation results; and
forwarding, to the FESC, the service operation results.

2. The method of claim 1, wherein a trust index is a metric that indicates a level of trustworthiness and is based on a trust evaluation of one or more trust indicators.

3. The method of claim 2, wherein the trust indicators comprise factors related to at least one of: security, privacy, resilience, performance, robustness, scalability, reputation, availability, accuracy, reliability, or consistency.

4. The method of claim 1, wherein the trust index of the FESC further comprises a user trust index (UTI).

5. The method of claim 1, further comprising:
receiving, from the FESC, an authentication request message; and
sending, to the FESC, an authentication response message.

6. The method of claim 5, wherein the authentication request message is a request for a trust index of the TIASCP and wherein the authentication request message comprises at least one of: an identifier of the FESP, an indication that indicates that the TIASCP should send its trust index back to the FESP; a user trust index (UTI), a device trust index (DTI), or a credential of the FESC.

7. The method of claim 1, wherein the first service operation request message comprises at least one of: an identifier of a User of the FESC, an identifier of a device of the FESC, an identifier of the FESC, a credential of the FESC, a trust index of the user (UTI), a trust index of the device (DTI), an identifier of a trust management function (TMF) from which the UTI and DTI may be retrieved, an identifier of target services the FESC wants to access from a FESP, a type of requested service operation of the target services, an identifier of the FESP, a type of FESP, an indication that the TIASCP should send an immediate response to the FESP; or a timer value indicating that the TIASCP should send an immediate response to the FESC before the timer value expires.

8. The method of claim 1, wherein the FESC trust index retrieval request message to the TMF comprises at least one of: an identifier of a user of the FESC, an identifier of a device of the FESC, an identifier of the TIASCP, or a credential of the TIASCP.

9. The method of claim 1, wherein authenticating the FESP based on the trust index of the FESP comprises: authorizing the FESP on a condition that the trust index of the FESP is greater than a trust index threshold value.

10. The method of claim 1, further comprising:
sending a service operation request authentication notification message to the FESC, that indicates whether the service operation request is accepted, rejected, or buffered.

11. A trust-index-aware service communication proxy (TIASCP), the TIASCP comprising:
a receiver;
a transmitter; and
a processor, wherein:
the receiver is further configured to receive, from a function entity service consumer (FESC), a first service operation request message that comprises a service operation request;
the transmitter is further configured to send, to a trust management function (TMF), a FESC trust index retrieval request message;
the receiver is further configured to receive, from the TMF, a FESC trust index retrieval response message that comprises a trust index of the FESC, wherein the trust index of the FESC comprises at least a device trust index (DTI);
the processor is configured to select a function entity service producer (FESP) based on the trust index of the FESC;
the processor is further configured to authenticate the service operation request based on the trust index of the FESC;
the transmitter is further configured to send, to the TMF, a FESP trust index retrieval request message;
the receiver is further configured to receive, from the TMF, a FESP trust index retrieval response message that includes a trust index of the FESP;
the processor is further configured to authenticate the FESP based on the trust index of the FESP;
the transmitter is further configured to forward, to the FESP, a modified service operation request in a second service operation request message, wherein the modified service operation request comprises an identifier of the TIASCP;
the receiver is further configured to receive, from the FESP, a service operation response message that comprises service operation results; and
the transmitter is further configured to forward, to the FESC, the service operation results.

12. The TIASCP of claim 11, wherein a trust index is a metric that indicates a level of trustworthiness and is based on a trust evaluation of one or more trust indicators.

13. The TIASCP of claim 12, wherein the trust indicators comprise factors related to at least one of: security, privacy, resilience, performance, robustness, scalability, reputation, availability, accuracy, reliability, or consistency.

14. The TIASCP of claim 11, wherein the trust index of the FESC further comprises a user trust index (UTI).

15. The TIASCP of claim 11, wherein:
the receiver is further configured to receive, from the FESC, an authentication request message; and
the transmitter is further configured to send, to the FESC, an authentication response message.

16. The TIASCP of claim 15, wherein the authentication request message is a request for a trust index of the TIASCP and wherein the authentication request message comprises at least one of: an identifier of the FESP, an indication that indicates that the TIASCP should send its trust index back to the FESP; a user trust index (UTI), a device trust index (DTI), or a credential of the FESC.

17. The TIASCP of claim 11, wherein the first service operation request message comprises at least one of: an identifier of a User of the FESC, an identifier of a device of the FESC, an identifier of the FESC, a credential of the FESC, a trust index of the user (UTI), a trust index of the device (DTI), an identifier of a trust management function (TMF) from which the UTI and DTI may be retrieved, an identifier of target services the FESC wants to access from a FESP, a type of requested service operation of the target services, an identifier of the FESP, a type of FESP, an indication that the TIASCP should send an immediate response to the FESP; or a timer value indicating that the TIASCP should send an immediate response to the FESC before the timer value expires.

18. The TIASCP of claim 11, wherein the FESC trust index retrieval request message to the TMF comprises at least one of: an identifier of a user of the FESC, an identifier of a device of the FESC, an identifier of the TIASCP, or a credential of the TIASCP.

19. The TIASCP of claim 11, wherein the processor is configured to authenticate the FESP based on the trust index of the FESP by authorizing the FESP on a condition that the trust index of the FESP is greater than a trust index threshold value.

20. The TIASCP of claim 11, wherein the transmitter is further configured to send a service operation request authentication notification message to the FESC, that indicates whether the service operation request is accepted, rejected, or buffered.
